(19) United States
(12) Patent Application Publication
(10) Pub. No.: US 2026/0231221 A1
(43) Pub. Date: Aug. 6, 2026

(54) TECHNIQUES FOR RANDOM ACCESS RESPONSE TRIGGERING FOR CHANNEL STATE INFORMATION REPORTING

(71) Applicant: QUALCOMM Incorporated, San Diego, CA (US)

(72) Inventors: Jae Ho RYU, San Diego, CA (US); Changhwan PARK, San Diego, CA (US); Lei XIAO, San Jose, CA (US)

(21) Appl. No.: 19/047,202

(22) Filed: Feb. 6, 2025

(51) Int. Cl. H04W 74/0833; H04B 7/06; H04L 27/26; H04W 72/0446

(52) U.S. Cl. CPC H04W 74/0833; H04B 7/0626; H04L 27/26025; H04W 72/0446

(57) ABSTRACT

Various aspects of the present disclosure generally relate to wireless communication. In some aspects, a user equipment (UE) may receive, from a network node, a random access response (RAR) message that triggers channel state information (CSI) reporting. The UE may receive, from the network node at a first time offset relative to the RAR message, one or more reference signals in accordance with the RAR message triggering the CSI report. The UE may transmit, to the network node at a second time offset relative to the RAR message, a CSI report in accordance with the one or more reference signals. Numerous other aspects are described.

### FIELD OF THE DISCLOSURE

Aspects of the present disclosure generally relate to wireless communication and specifically relate to techniques, apparatuses, and methods associated with techniques for random access response triggering for channel state information reporting.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some examples of wireless communications, a network node and a user equipment (UE) may establish a wireless connection in accordance with a random access procedure (e.g., a random access channel (RACH) procedure). For example, a RACH procedure may be associated with initial access, handovers, beam recovery, or re-establishing uplink synchronization. Additionally, there may be multiple types of RACH procedures (e.g., 4-step RACH and 2-step RACH). Additionally, the UE and the network node may perform a channel state information (CSI) procedure to determine one or more transmission parameters. In some examples, the network node May transmit a physical downlink control channel (PDCCH) message that triggers the UE to monitor for and receive one or more reference signals. Accordingly, the network node may transmit, and the UE may receive, the one or more reference signals. The UE may perform one or more measurements on the reference signals to determine a set of transmission parameters. Therefore, the UE may transmit the CSI report to the network node, such that the network node may transmit one or more subsequent downlink transmissions in accordance with the one or more transmission parameters of the CSI report.

### SUMMARY

The systems, methods, and devices of this disclosure each have several innovative aspects, no single one of which is solely responsible for the desirable attributes disclosed herein.

Some aspects described herein relate to a method of wireless communication performed by a user equipment (UE). The method may include receiving, from a network node, a random access response (RAR) message that triggers channel state information (CSI) reporting. The method may include receiving, from the network node at a first time offset relative to the RAR message, one or more reference signals in accordance with the RAR message triggering the CSI report. The method may include transmitting, to the network node at a second time offset relative to the RAR message, a CSI report in accordance with the one or more reference signals.

Some aspects described herein relate to a method of wireless communication performed by a network node. The method may include transmitting, to a UE, an RAR message that triggers CSI reporting. The method may include transmitting, to the UE, at a first time offset relative to the RAR message, one or more reference signals in accordance with the RAR message triggering the CSI report. The method may include receiving, from the UE at a second time offset relative to the RAR message, a CSI report in accordance with the one or more reference signals.

Some aspects described herein relate to a UE for wireless communication. The UE may include one or more memories and one or more processors coupled to the one or more memories. The one or more processors, individually or collectively, may be configured to receive, from a network node, an RAR message that triggers CSI reporting. The one or more processors, individually or collectively, may be configured to receive, from the network node at a first time offset relative to the RAR message, one or more reference signals in accordance with the RAR message triggering the CSI report. The one or more processors, individually or collectively, may be configured to transmit, to the network node at a second time offset relative to the RAR message, a CSI report in accordance with the one or more reference signals.

Some aspects described herein relate to a network node for wireless communication. The network node may include one or more memories and one or more processors coupled to the one or more memories. The one or more processors, individually or collectively, may be configured to transmit, to a UE, an RAR message that triggers CSI reporting. The one or more processors, individually or collectively, may be configured to transmit, to the UE, at a first time offset relative to the RAR message, one or more reference signals in accordance with the RAR message triggering the CSI report. The one or more processors, individually or collectively, may be configured to receive, from the UE at a second time offset relative to the RAR message, a CSI report in accordance with the one or more reference signals.

Some aspects described herein relate to a non-transitory computer-readable medium that stores a set of instructions for wireless communication by one or more instructions that, when executed by one or more processors of a UE. The set of instructions, when executed by one or more processors of the UE, may cause the UE to transmit to receive, from a network node, an RAR message that triggers CSI reporting. The set of instructions, when executed by one or more processors of the UE, may cause the UE to receive, from the network node at a first time offset relative to the RAR message, one or more reference signals in accordance with the RAR message triggering the CSI report. The set of instructions, when executed by one or more processors of the UE, may cause the UE to transmit, to the network node at a second time offset relative to the RAR message, a CSI report in accordance with the one or more reference signals.

Some aspects described herein relate to a non-transitory computer-readable medium that stores a set of instructions for wireless communication by a network node. The set of instructions, when executed by one or more processors of the network node, may cause the network node to transmit, to a UE, an RAR message that triggers CSI reporting. The set of instructions, when executed by one or more processors of the network node, may cause the network node to transmit, to the UE, at a first time offset relative to the RAR message, one or more reference signals in accordance with the RAR message triggering the CSI report. The set of instructions, when executed by one or more processors of the network node, may cause the network node to receive, from the UE at a second time offset relative to the RAR message, a CSI report in accordance with the one or more reference signals.

Some aspects described herein relate to an apparatus for wireless communication. The apparatus may include means for receiving, from a network node, an RAR message that triggers CSI reporting. The apparatus may include means for receiving, from the network node at a first time offset relative to the RAR message, one or more reference signals in accordance with the RAR message triggering the CSI report. The apparatus may include means for transmitting, to the network node at a second time offset relative to the RAR message, a CSI report in accordance with the one or more reference signals.

Some aspects described herein relate to an apparatus for wireless communication. The apparatus may include means for transmitting, to a UE, an RAR message that triggers CSI reporting. The apparatus may include means for transmitting, to the UE, at a first time offset relative to the RAR message, one or more reference signals in accordance with the RAR message triggering the CSI report. The apparatus may include means for receiving, from the UE at a second time offset relative to the RAR message, a CSI report in accordance with the one or more reference signals.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating an example of a two-step random access procedure.

FIG. 4 is a diagram illustrating an example of a four-step random access procedure.

FIG. 5 is a diagram illustrating an example of make-before-break handover.

FIG. 6 is a diagram illustrating an example of downlink control channel based channel state information (CSI) report triggering.

FIG. 7 is a diagram illustrating an example of secondary cell activation in accordance with a medium access control control element.

FIG. 8 is a diagram illustrating an example associated with a random access response (RAR) trigger for CSI reporting.

FIG. 9 is a diagram illustrating an example associated with signaling that enables RAR message triggering for CSI reporting.

FIG. 10 is a diagram illustrating an example process performed, for example, at a user equipment (UE) or an apparatus of a UE.

FIG. 11 is a diagram illustrating an example process performed, for example, at a network node or an apparatus of a network node.

FIG. 12 is a diagram of an example apparatus for wireless communication.

FIG. 13 is a diagram of an example apparatus for wireless communication.

### DETAILED DESCRIPTION

In some examples of wireless communications, a network node and a user equipment (UE) may establish a wireless connection in accordance with a random access procedure (e.g., a random access channel (RACH) procedure. For example, a RACH procedure may be associated with initial access, handovers, beam recovery, or re-establishing uplink synchronization. Additionally, there may be multiple types of RACH procedures (e.g., 4-step RACH and 2-step RACH).

The 4-step RACH may include four message exchanges between the UE and the network node, allowing for explicit contention resolution. In Message 1, the UE transmits a random access preamble over a physical RACH (PRACH) to initiate access. If contention-free RACH is used (e.g., during handovers), the network node may assign a unique preamble to the UE. Otherwise, in contention-based RACH, multiple UEs may select from a pool of available preambles. In Message 2, the network node may respond with a random access response (RAR) message via the physical downlink shared channel (PDSCH). The RAR message may include one or more of a timing advance command (TAC) to adjust uplink synchronization or an uplink grant for the UE to transmit to the network node in a next transmission. Upon receiving the RAR message, the UE may adjust a timing and prepare for an uplink transmission. In Message 3, the UE transmits the scheduled uplink message (Msg3) on a physical uplink shared channel (PUSCH) using the allocated uplink grant from the RAR message. The Msg3 may carry a random access control (RAC) connection request, a handover request, or other higher-layer signaling. In Message 4, the network node may transmit a contention resolution message via a physical downlink control channel (PDCCH). If the Msg3 is successfully received and decoded, the network node may assign the UE an identifier, completing the RACH procedure.

The 2-step RACH may combine one or more steps from the 4-step RACH procedure. In a message A (msgA), the UE may concurrently transmit a PRACH preamble and an uplink data transmission (similar to Msg3 of the 4-step RACH) over the PUSCH. In a message B (msgB), the network node responds with an RAR message that includes contention resolution, effectively combining Messages 2 and 4 from the 4-step RACH into a single step. If the network node successfully decodes the UE transmission and resolves contention, the UE may be granted access.

Additionally, the UE and the network node may perform a channel state information (CSI) procedure to determine one or more transmission parameters. In some examples, the network node may transmit a PDCCH message that triggers the UE to monitor for and receive one or more reference signals (e.g., CSI reference signals (CSI-RSs)). Accordingly, the network node may transmit, and the UE may receive, the one or more reference signals. The UE may perform one or more measurements on the reference signals to determine a set of transmission parameters (e.g., one or more of a rank indicator (RI), a channel quality indicator (CQI), or a precoding matrix indicator (PMI)). Therefore, the UE may transmit the CSI report to the network node, such that the network node may transmit one or more subsequent downlink transmissions in accordance with the one or more transmission parameters of the CSI report.

In some examples, the network node and the UE may perform a CSI procedure after starting a RACH procedure used for the UE to execute handover from a previous network node (e.g., a source network node) to the network node (e.g., a target network node). However, performing a handover execution and a CSI reporting procedure in sequence may be associated with a reduction in data throughput. For example, both handover and CSI reporting may be associated with a duration of time where data throughput may be reduced while the network node and the UE establish a link for wireless communications and determine transmission parameters. Accordingly, triggering a CSI reporting procedure after executing handover may result in data throughput degradation between the network node and the UE.

Various aspects relate generally to triggering CSI reporting via the RAR message of the RACH procedure. Some aspects more specifically relate to the network node transmitting an RAR message that requests CSI reporting during a RACH procedure with the UE. In some aspects, the network node may transmit, and the UE may receive, one or more reference signals (e.g., CSI-RSs) in accordance with the RAR message triggering the CSI reporting. Additionally, the UE may generate a CSI report based on measuring the one or more reference signals in accordance with the RAR message triggering the CSI reporting. Accordingly, the UE may transmit, and the network node may receive, the CSI report based on RAR message triggering.

The network node may transmit the one or more reference signals at a first time offset relative to the RAR message and the UE may transmit the CSI report at a second time offset relative to the RAR message. In some examples, the first time offset and the second time offset may account for a duration of time for the UE to perform PDSCH decoding and medium access control (MAC) layer decoding on the RAR message. For example, processing an RAR message via the MAC layer may take more time than processing a PDCCH message via a physical (PHY) layer. Therefore, the first time offset and the second time offset may enable enough time for the UE to process the RAR message and perform the associated CSI reporting procedure.

Particular aspects of the subject matter described in this disclosure can be implemented to realize one or more of the following potential advantages. In some examples, the described techniques can be used to increase data throughput between the network node and the UE. For example, by triggering CSI reporting via the RAR message (e.g., rather than triggering via a PDCCH message after handover execution), the network node and the UE may reduce the duration of time associated with establishing a wireless communication link and determining the transmission parameters. Accordingly, the network node and the UE may begin communicating data messages earlier, increasing data throughput. In some examples, the described techniques can be used to enable CSI reporting via an RAR message. For example, the first time offset and the second time offset may account for PDSCH decoding and MAC layer processing of the RAR message, which may enable the UE to complete processing of the RAR message before receiving the one or more reference signals and transmitting the CSI report.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mm Wave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

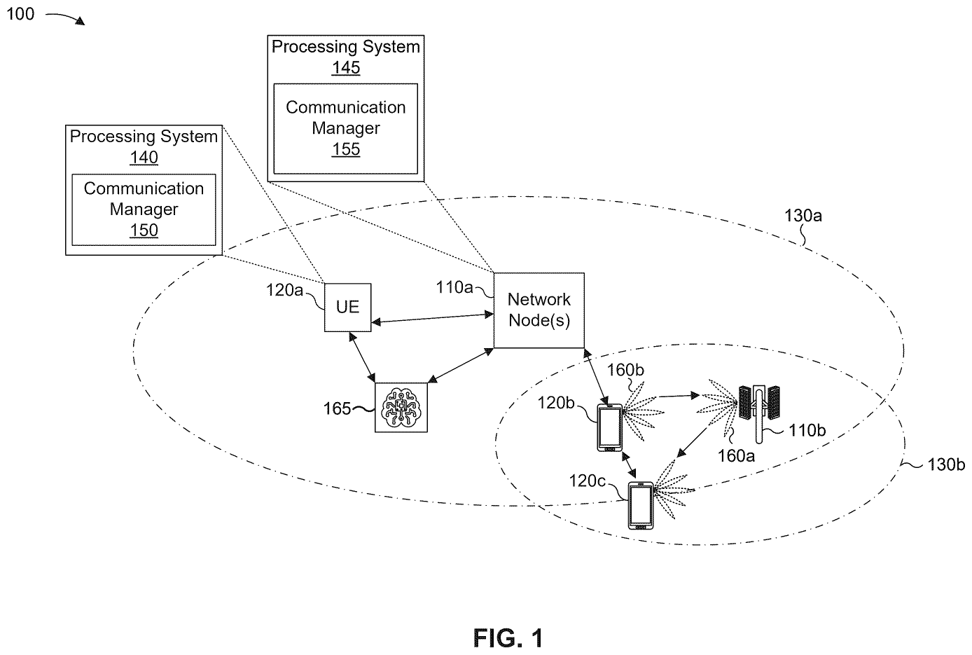

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IOT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may receive, from a network node, a random access response (RAR) message that triggers channel state information (CSI) reporting; receive, from the network node at a first time offset relative to the RAR message, one or more reference signals in accordance with the RAR message triggering the CSI report; and transmit, to the network node at a second time offset relative to the RAR message, a CSI report in accordance with the one or more reference signals. Additionally, or alternatively, the communication manager 150 may perform one or more other operations described herein.

In some aspects, the network node 110 may include a communication manager 155. As described in more detail elsewhere herein, the communication manager 155 may transmit, to a UE, an RAR message that triggers CSI reporting; transmit, to the UE, at a first time offset relative to the RAR message, one or more reference signals in accordance with the RAR message triggering the CSI report; and receive, from the UE at a second time offset relative to the RAR message, a CSI report in accordance with the one or more reference signals. Additionally, or alternatively, the communication manager 155 may perform one or more other operations described herein.

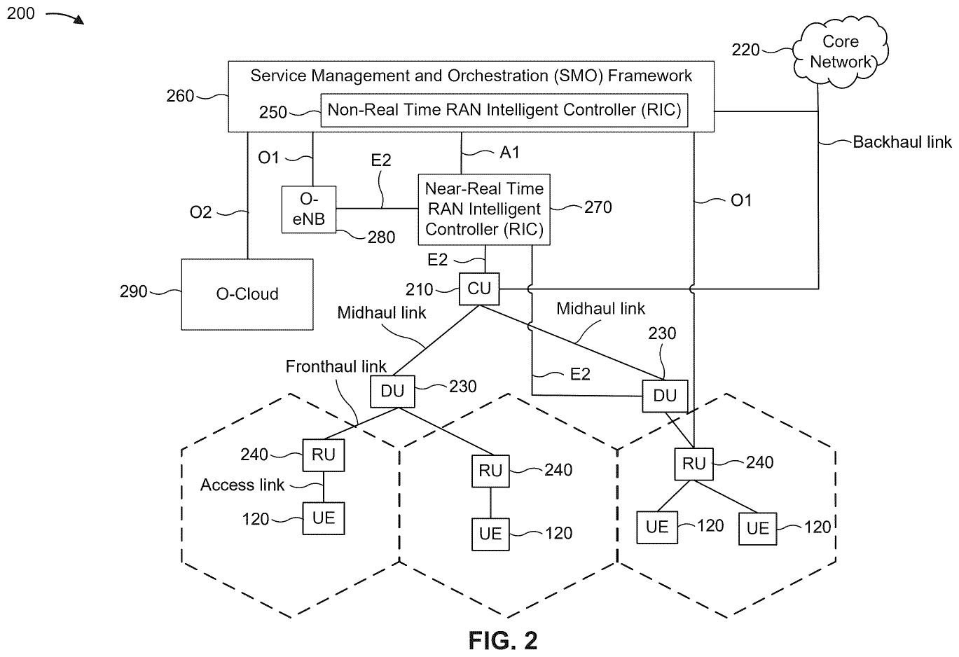

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

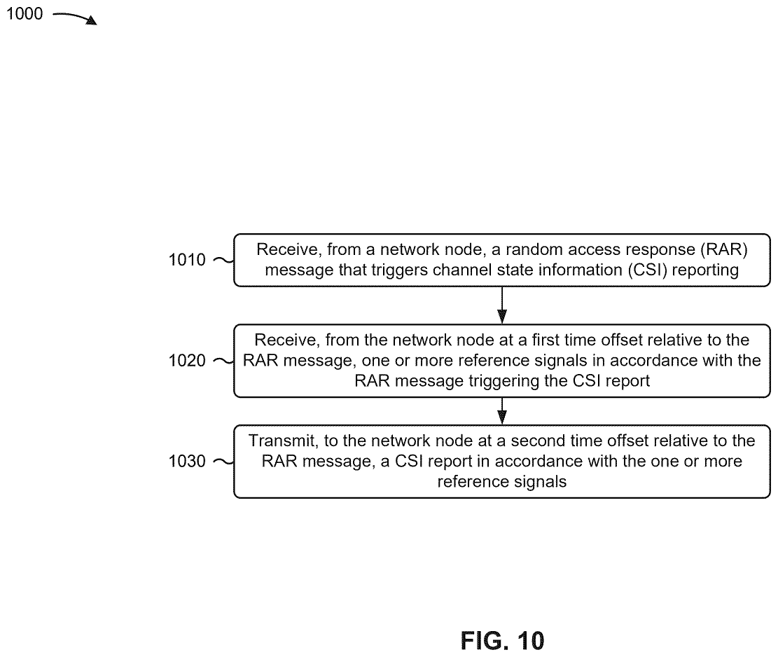

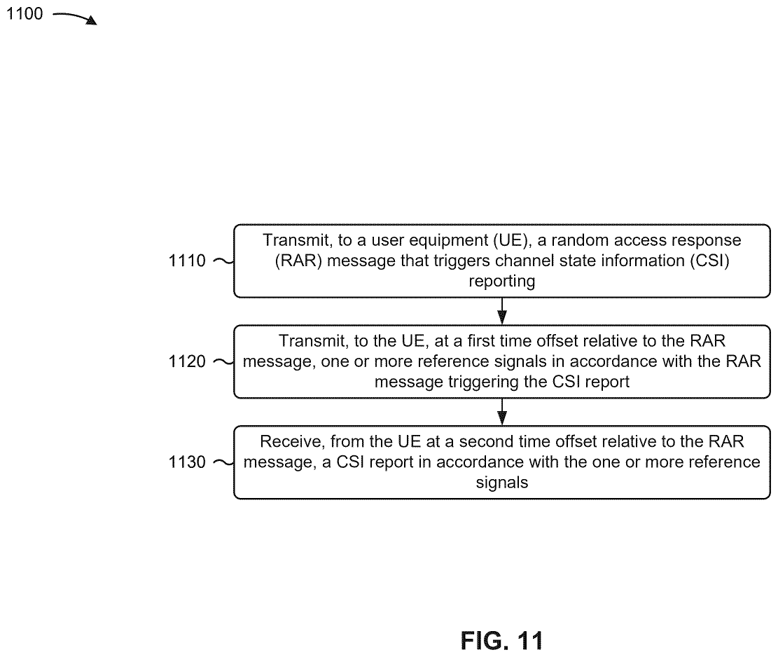

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with techniques for RAR triggering for CSI reporting, as described in more detail elsewhere herein. For example, the processing system 145 of the network node 110, the processing system 140 of the UE 120, the CU 210, the DU 230, or the RU 240 may perform or direct operations of, for example, process 1000 of FIG. 10, process 1100 of FIG. 11, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1000 of FIG. 10, process 1100 of FIG. 11, or other processes as described herein. In some examples, executing instructions may include running the instructions, converting the instructions, compiling the instructions, or interpreting the instructions, among other examples.

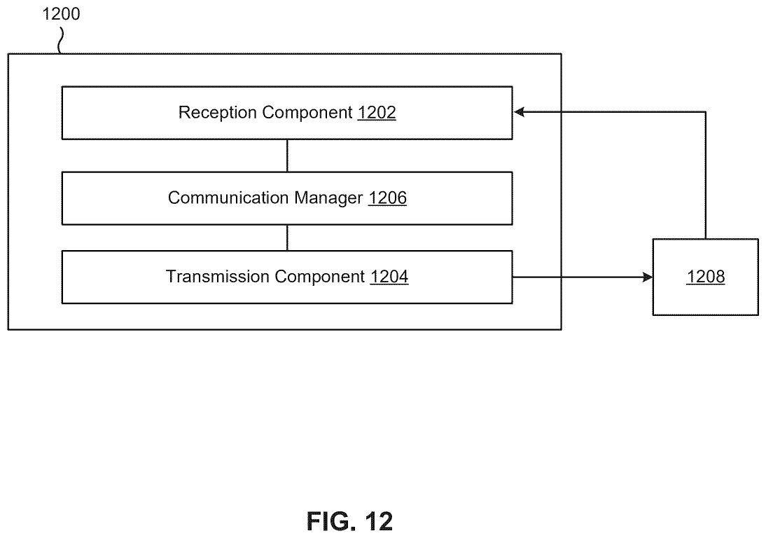

In some aspects, a UE includes means for receiving, from a network node, an RAR) message that triggers CSI reporting; means for receiving, from the network node at a first time offset relative to the RAR message, one or more reference signals in accordance with the RAR message triggering the CSI report; or means for transmitting, to the network node at a second time offset relative to the RAR message, a CSI report in accordance with the one or more reference signals. The means for the UE to perform operations described herein may include, for example, one or more of communication manager 150, processing system 140, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

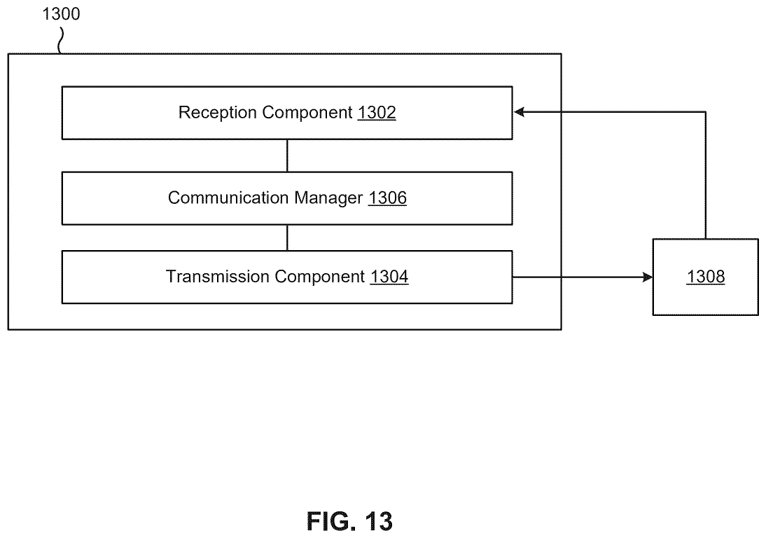

In some aspects, the network node includes means for transmitting, to a UE, an RAR message that triggers CSI reporting; means for transmitting, to the UE, at a first time offset relative to the RAR message, one or more reference signals in accordance with the RAR message triggering the CSI report; or means for receiving, from the UE at a second time offset relative to the RAR message, a CSI report in accordance with the one or more reference signals. The means for the network node to perform operations described herein may include, for example, one or more of communication manager 155, processing system 145, a radio, one or more RF chains, one or more transceivers, one or more antennas, one or more modems, a reception component (for example, reception component 1302 depicted and described in connection with FIG. 13), or a transmission component (for example, transmission component 1304 depicted and described in connection with FIG. 13), among other examples.

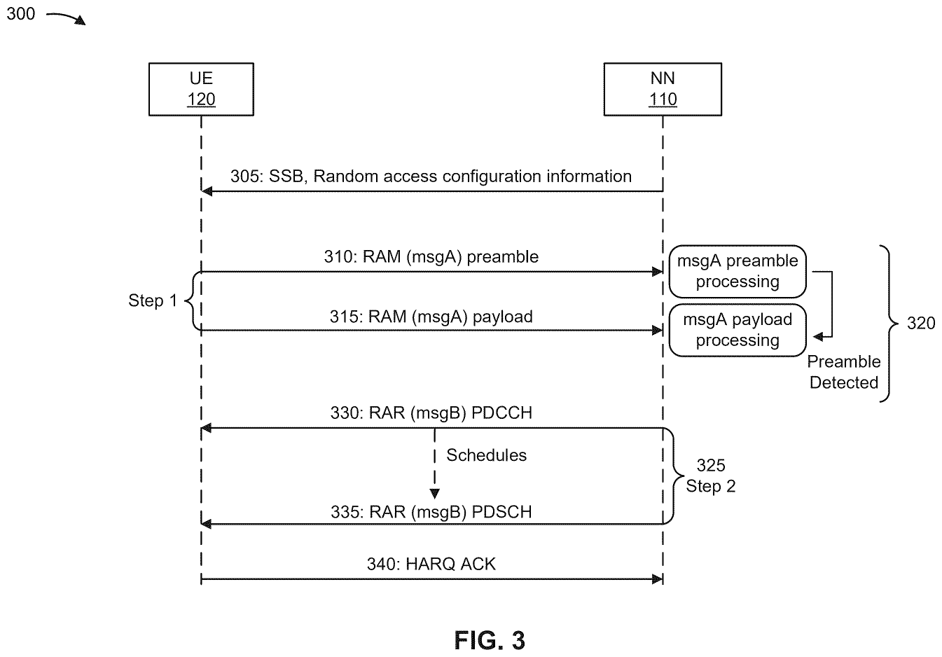

FIG. 3 is a diagram illustrating an example 300 of a two-step random access procedure. As shown in FIG. 3, a network node 110 and a UE 120 may communicate with one another to perform the two-step random access procedure.

As shown by reference number 305, the network node 110 may transmit, and the UE 120 may receive, one or more synchronization signal blocks (SSBs) and random access configuration information. In some aspects, the random access configuration information may be transmitted in or indicated by system information (e.g., in one or more system information blocks (SIBs)) or an SSB, such as for contention-based random access. Additionally, or alternatively, the random access configuration information may be transmitted in a radio resource control (RRC) message or a physical downlink control channel (PDCCH) order message that triggers a RACH procedure, such as for contention-free random access. The random access configuration information may include one or more parameters to be used in the two-step random access procedure, such as one or more parameters for transmitting a random access message (RAM) or receiving a random access response (RAR) to the RAM.

As shown by reference number 310, the UE 120 may transmit, and the network node 110 may receive, a RAM preamble. As shown by reference number 315, the UE 120 may transmit, and the network node 110 may receive, a RAM payload. As shown, the UE 120 may transmit the RAM preamble and the RAM payload to the network node 110 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a physical random access channel (PRACH) preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, uplink control information (UCI), or a physical uplink shared channel (PUSCH) transmission).

As shown by reference number 320, the network node 110 may receive the RAM preamble transmitted by the UE 120. If the network node 110 successfully receives and decodes the RAM preamble, the network node 110 may then receive and decode the RAM payload.

As shown by reference number 325, the network node 110 may transmit an RAR (sometimes referred to as an RAR message). As shown, the network node 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, or contention resolution information.

As shown by reference number 330, as part of the second step of the two-step random access procedure, the network node 110 may transmit a physical downlink control channel (PDCCH) communication for the RAR. The PDCCH communication may schedule a physical downlink shared channel (PDSCH) communication that includes the RAR. For example, the PDCCH communication may indicate a resource allocation (e.g., in downlink control information (DCI)) for the PDSCH communication.

As shown by reference number 335, as part of the second step of the two-step random access procedure, the network node 110 may transmit the PDSCH communication for the RAR, as scheduled by the PDCCH communication. The RAR may be included in a medium access control (MAC) protocol data unit (PDU) of the PDSCH communication. As shown by reference number 340, if the UE 120 successfully receives the RAR, the UE 120 may transmit a hybrid automatic repeat request (HARQ) acknowledgement (ACK).

As indicated above, FIG. 3 is provided as an example. Other examples may differ from what is described with regard to FIG. 3.

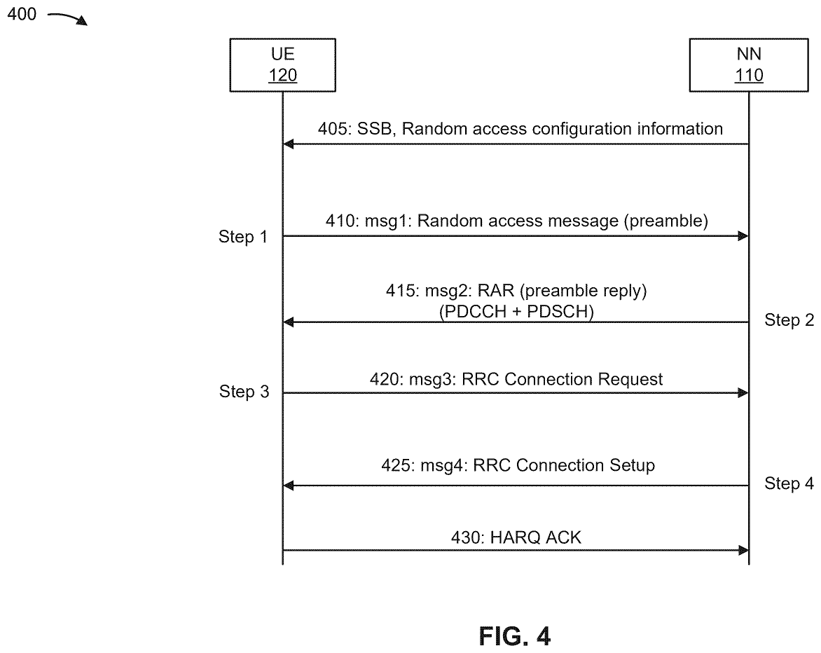

FIG. 4 is a diagram illustrating an example 400 of a four-step random access procedure. As shown in FIG. 4, a network node 110 and a UE 120 may communicate with one another to perform the four-step random access procedure.

As shown by reference number 405, the network node 110 may transmit, and the UE 120 may receive, one or more SSBs and random access configuration information. In some aspects, the random access configuration information may be transmitted in or indicated by system information (e.g., in one or more system information blocks (SIBs)) or an SSB, such as for contention-based random access. Additionally, or alternatively, the random access configuration information may be transmitted in a radio resource control (RRC) message or a physical downlink control channel (PDCCH) order message that triggers a RACH procedure, such as for contention-free random access. The random access configuration information may include one or more parameters to be used in the random access procedure, such as one or more parameters for transmitting a RAM or one or more parameters for receiving an RAR.

As shown by reference number 410, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 415, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC PDU of the PDSCH communication.

As shown by reference number 420, the UE 120 may transmit an RRC connection request message. The RRC connection request message may be referred to as message 3, msg3, MSG3, or a third message of a four-step random access procedure. In some aspects, the RRC connection request may include a UE identifier, UCI, or a PUSCH communication (e.g., an RRC connection request).

As shown by reference number 425, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, or contention resolution information. As shown by reference number 430, if the UE 120 successfully receives the RRC connection setup message, the UE 120 may transmit a HARQ ACK.

As indicated above, FIG. 4 is provided as an example. Other examples may differ from what is described with regard to FIG. 4.

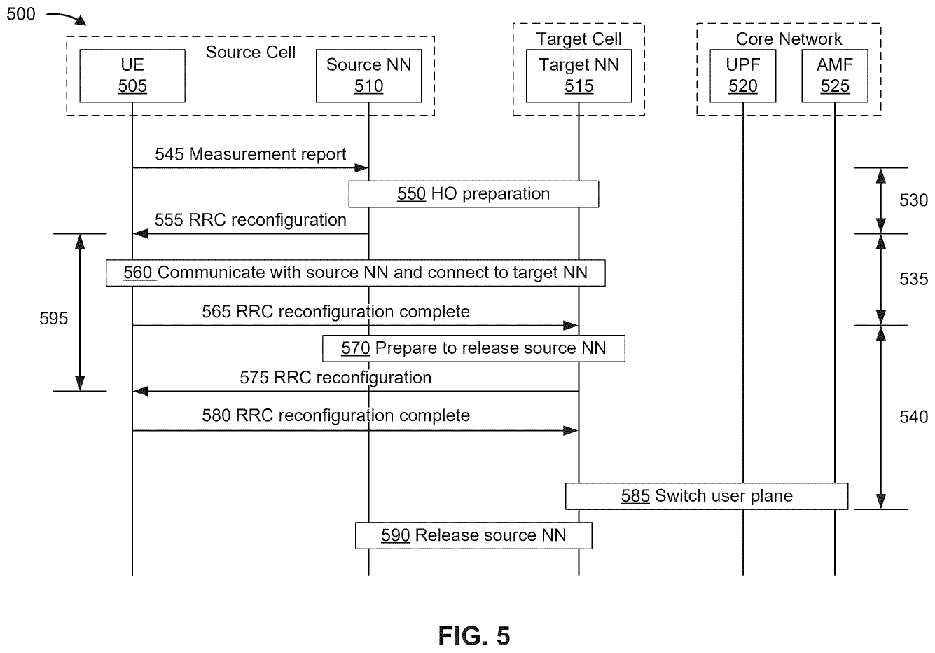

FIG. 5 is a diagram illustrating an example 500 of make-before-break handover.

As shown in FIG. 5, a make-before-break (MBB) handover procedure may involve a UE 505, a source network node 510, a target network node 515, a user plane function (UPF) device 520, and an access and mobility management function (AMF) device 525. In some examples, actions described as being performed by a network node may be performed by multiple different network nodes. For example, configuration actions or core network communication actions may be performed by a first network node (e.g., a CU or a DU), and radio communication actions may be performed by a second network node (e.g., a DU or an RU). The UE 505 may correspond to the UE 120 described elsewhere herein. The source network node 510 or the target network node 515 may correspond to the network node 110 described elsewhere herein. The UPF device 520 or the AMF device 525 may correspond to the network controller described elsewhere herein. The UE 505 and the source network node 510 may be connected (e.g., may have a radio resource control (RRC) connection) via a serving cell or a source cell, and the UE 505 may undergo a handover to the target network node 515 via a target cell. The UPF device 520 or the AMF device 525 may be located within a core network. The source network node 510 and the target network node 515 may be in communication with the core network for mobility support and user plane functions. The MBB handover procedure may include an enhanced MBB (eMBB) handover procedure.

As shown, the MBB handover procedure may include a handover preparation phase 530, a handover execution phase 535, and a handover completion phase 540. During the handover preparation phase 530, the UE 505 may report measurements that cause the source network node 510 or the target network node 515 to prepare for handover and trigger execution of the handover. During the handover execution phase 535, the UE 505 may execute the handover by performing a random access procedure with the target network node 515 and establishing an RRC connection with the target network node 515. During the handover completion phase 540, the source network node 510 may forward stored communications associated with the UE 505 to the target network node 515, and the UE 505 may be released from a connection with the source network node 510.

As shown by reference number 545, the UE 505 may perform one or more measurements, and may transmit a measurement report to the source network node 510 based at least in part on performing the one or more measurements (e.g., serving cell measurements or neighbor cell measurements). The measurement report may indicate, for example, a reference signal received power (RSRP) parameter, a reference signal received quality (RSRQ) parameter, a received signal strength indicator (RSSI) parameter, or a signal-to-interference-plus-noise-ratio (SINR) parameter (e.g., for the serving cell or one or more neighbor cells). The source network node 510 may use the measurement report to determine whether to trigger a handover to the target network node 515. For example, if one or more measurements satisfy a condition, then the source network node 510 may trigger a handover of the UE 505 to the target network node 515.

As shown by reference number 550, the source network node 510 and the target network node 515 may communicate with one another to prepare for a handover of the UE 505. As part of the handover preparation, the source network node 510 may transmit a handover request to the target network node 515 to instruct the target network node 515 to prepare for the handover. The source network node 510 may communicate radio resource control (RRC) context information associated with the UE 505 or configuration information associated with the UE 505 to the target network node 515. The target network node 515 may prepare for the handover by reserving resources for the UE 505. After reserving the resources, the target network node 515 may transmit an acknowledgement (ACK) to the source network node 510 in response to the handover request.

As shown by reference number 555, the source network node 510 may transmit an RRC reconfiguration message to the UE 505. The RRC reconfiguration message may include a handover command instructing the UE 505 to execute a handover procedure from the source network node 510 to the target network node 515. The handover command may include information associated with the target network node 515, such as a random access channel (RACH) preamble assignment for accessing the target network node 515. Reception of the RRC reconfiguration message, including the handover command, by the UE 505 may trigger the start of the handover execution phase 535.

As shown by reference number 560, during the handover execution phase 535 of the MBB handover, the UE 505 may execute the handover by performing a random access procedure with the target network node 515 (e.g., including synchronization with the target network node 515) while continuing to communicate with the source network node 510. For example, while the UE 505 is performing the random access procedure with the target network node 515, the UE 505 may transmit uplink data, uplink control information, or an uplink reference signal (e.g., a sounding reference signal) to the source network node 510, or may receive downlink data, downlink control information, or a downlink reference signal from the source network node 510. For example, the target network node 515 may transmit, and the UE 505 may receive, one or more CSI-RSs. Accordingly, the UE 505 may perform CSI measurements to generate a CSI report for transmission to the target network node 515.

As shown by reference number 565, upon successfully establishing a connection with the target network node 515 (e.g., via a random access procedure), the UE may transmit an RRC reconfiguration completion message to the target network node 515. Reception of the RRC reconfiguration message by the target network node 515 may trigger the start of the handover completion phase 540.

As shown by reference number 570, the source network node 510 and the target network node 515 may communicate with one another to prepare for release of the connection between the source network node 510 and the UE 505. In some aspects, the target network node 515 may determine that a connection between the source network node 510 and the UE 505 is to be released, such as after receiving the RRC reconfiguration message from the UE 505. In this case, the target network node 515 may transmit a handover connection setup completion message to the source network node 510. The handover connection setup completion message may cause the source network node 510 to stop transmitting data to the UE 505 or to stop receiving data from the UE 505. Additionally, or alternatively, the handover connection setup completion message may cause the source network node 510 to forward communications associated with the UE 505 to the target network node 515 or to notify the target network node 515 of a status of one or more communications with the UE 505. For example, the source network node 510 may forward, to the target network node 515, buffered downlink communications (e.g., downlink data) for the UE 505 or uplink communications (e.g., uplink data) received from the UE 505. Additionally, or alternatively, the source network node 510 may notify the target network node 515 regarding a packet data convergence protocol (PDCP) status associated with the UE 505 or a sequence number to be used for a downlink communication with the UE 505.

As shown by reference number 575, the target network node 515 may transmit an RRC reconfiguration message to the UE 505 to instruct the UE 505 to release the connection with the source network node 510. Upon receiving the instruction to release the connection with the source network node 510, the UE 505 may stop communicating with the source network node 510. For example, the UE 505 may refrain from transmitting uplink communications to the source network node 510 or may refrain from monitoring for downlink communications from the source network node 510.

As shown by reference number 580, the UE may transmit an RRC reconfiguration completion message to the target network node 515 to indicate that the connection between the source network node 510 and the UE 505 is being released or has been released.

As shown by reference number 585, the target network node 515, the UPF device 520, or the AMF device 525 may communicate to switch a user plane path of the UE 505 from the source network node 510 to the target network node 515. Prior to switching the user plane path, downlink communications for the UE 505 may be routed through the core network to the source network node 510. After the user plane path is switched, downlink communications for the UE 505 may be routed through the core network to the target network node 515. Upon completing the switch of the user plane path, the AMF device 525 may transmit an end marker message to the source network node 510 to signal completion of the user plane path switch. As shown by reference number 590, the target network node 515 and the source network node 510 may communicate to release the source network node 510.

As part of the MBB handover procedure, the UE 505 may maintain simultaneous connections with the source network node 510 and the target network node 515 during a time period 595. The time period 595 may start at the beginning of the handover execution phase 535 (e.g., upon reception by the UE 505 of a handover command from the source network node 510) when the UE 505 performs a random access procedure with the target network node 515. The time period 595 may end upon release of the connection between the UE 505 and the source network node 510 (e.g., upon reception by the UE 505 of an instruction, from the target network node 515, to release the source network node 510). By maintaining simultaneous connections with the source network node 510 and the target network node 515, the handover procedure can be performed with zero or a minimal interruption to communications, thereby reducing latency.

As indicated above, FIG. 5 is provided as an example. Other examples may differ from what is described with respect to FIG. 5.

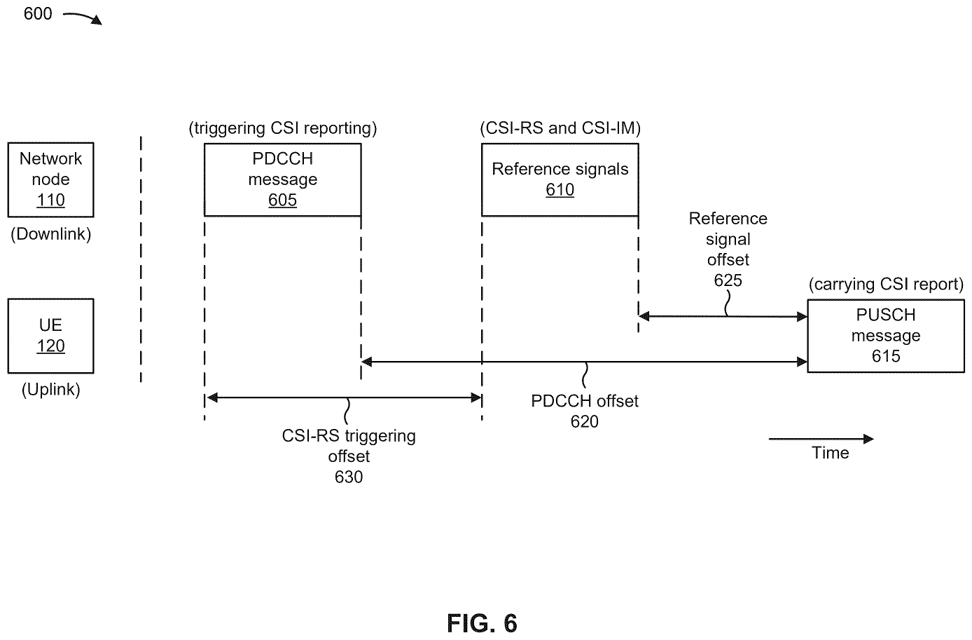

FIG. 6 is a diagram illustrating an example 600 of downlink control channel based CSI report triggering. In some instances, example 600 may implement or be implemented by one or more aspects of FIGS. 1 through 5. For instance, FIG. 6 may illustrate wireless communications between the network node 110 and the UE 120.

As shown in FIG. 6, the network node 110 may transmit, and the UE 120 may receive, a PDCCH message 605 that triggers a CSI reporting procedure. With reference to example 600, the CSI reporting procedure may be aperiodic. For example, aperiodic CSI reporting may be a dynamic feedback mechanism where the UE 120 may provide channel quality measurements to the network node 110 in accordance with explicit triggering by the network node 110. In some examples, the network node 110 may initiate the CSI reporting procedure in accordance with transmitting a PDCCH message 605. For example, the PDCCH message 605 may include a DCI format (e.g., a triggering DCI) that instructs the UE 120 to perform CSI measurements. Additionally, the PDCCH message 605 may trigger the network node 110 to transmit one or more reference signals 610, enabling the UE 120 to measure and evaluate the most recent channel conditions.

In accordance with transmitting the PDCCH message 605, the network node 110 may transmit, and the UE 120 may receive, the one or more reference signals 610. In some examples, the one or more reference signals 610 may include one or more of CSI-RSs or CSI interference measurement reference signals (CSI-IMs). For instance, the UE 120 may use a CSI-RS to estimate the quality of an associated transmission channel (such as one or more of path loss, fading, or interference associated with the transmission). Additionally, a CSI-IM may enable the UE 120 to measure interference levels, enabling additional reporting of channel conditions associated with the transmission channel.

In accordance with receiving the reference signals 610, the UE 120 may measure, process, and generate a CSI report based on one or more configured feedback parameters. In some examples, the CSI report may include one or more of an RI (e.g., indicates a number of spatial layers that the transmission channel may support), a CQI (e.g., indicates a permissible MCS that can be used for data transmissions), or a PMI (e.g., indicates feedback on a precoding scheme for MIMO transmissions).

After generating the CSI report, the UE 120 may transmit, and the network node 110 may receive, the CSI report as part of a PUSCH message 615 (e.g., the UE 120 transmits the CSI report via a PUSCH). Accordingly, the network node 110 may decode the CSI report and dynamically adapt transmission parameters associated with the transmission channel in accordance with the one or more parameters included in the CSI report.

In some examples of aperiodic CSI reporting, a configuration of a non-zero power (NZP) CSI-RS resource set (e.g., NZP-CSI-RS-ResourceSet) may indicate how the UE 120 measures the transmission channel. For example, the network node 110 may transmit, and the UE 120 may receive, control signaling (e.g., RRC signaling) that configures one or more parameters included in or associated with the NZP-CSI-RS-ResourceSet. In some examples, the NZP-CSI-RS-ResourceSet may indicate which reference signals 610 the UE 120 should monitor for CSI estimation. These resource sets may define parameters such as the frequency domain locations of the CSI-RSs or the CSI-IMs, time-domain periodicity, and associated measurement filtering settings. By configuring NZP-CSI-RS-ResourceSet parameters, the network node 110 can fine-tune CSI acquisition, enabling the UE 120 to provide accurate and timely feedback for wireless link adaptation.

If aperiodic CSI-RS is used in accordance with the aperiodic CSI reporting for example 600, then a CSI-RS triggering offset 630 may be configured per resource set by a parameter aperiodicTriggeringOffset (e.g., included in the NZP-CSI-RS-ResourceSet). In some examples, the aperiodicTriggeringOffset parameter may define the CSI-RS triggering offset 630 between the reception of the PDCCH message 605 that triggers the aperiodic CSI report and the transmission of the corresponding CSI-RSs and CSI-IMs (e.g., the reference signals 610). The network node 110 may configure the CSI-RS triggering offset 630 per resource set and can range from zero to four slots. In some examples, the CSI-RS triggering offset 630 may enable the UE 120 to have sufficient time to prepare for CSI measurement after receiving a triggering DCI (e.g., in the PDCCH message 605). If one or more associated trigger states for the one or more reference signals 610 lack a higher-layer parameter qcl-Type (e.g., set to ‘QCL-TypeD’ in a corresponding transmission configuration indicator (TCI) state), then the aperiodicTriggeringOffset may be fixed at zero. Additionally, the aperiodic triggering offset for CSI-IMs may align with that of the associated NZP CSI-RSs (e.g., the CSI-IMs and NZP CSI-RSs included in the reference signals 610 are both associated with a same aperiodicTriggeringOffset). In examples where aperiodicTriggeringOffset is set to zero, the network node 110 may start transmitting the PDCCH message 605 and the one or more reference signals 610 in a same time interval (e.g., in the same slot).

As shown in FIG. 6, there may be a PDCCH offset 620 (e.g., a value of Z time intervals, where Z is an integer). In some examples, the PDCCH offset 620 may be a permissible (e.g., minimum) duration between a last OFDM symbol of the PDCCH message 605 that triggers the aperiodic CSI reporting and an initial OFDM symbol of the PUSCH message 615. Additionally, there may be a reference signal offset 625 (e.g., a value of Z′ time intervals, where Z′ is an integer). In some examples, the reference signal offset 625 may be a permissible (e.g., minimum) duration between a last OFDM symbol of a CSI resource (e.g., a channel measurement resource (CMR) or interference measurement resource (IMR)) included in the one or more reference signals 610 and an initial OFDM symbol of the PUSCH message 615 carrying the CSI reporting. Therefore, a time interval during which the UE 120 may initiate transmission of the PUSCH message 615 may satisfy both the PDCCH offset 620 and the reference signal offset 625. In some examples, the term “time interval” as used herein may refer to one or more symbols, one or more frames, one or more subframes, one or more mini-slots, one or more sub-slots, or one or more slots.

In some examples, the CSI reporting procedure of example 600 may be associated with a handover procedure. For example, the network node 110 may be an example of the target network node 515 that may transmit the PDCCH message 605 after the handover execution phase 535. For example, the network node 110 and UE 120 may initiate the aperiodic CSI reporting procedures after the handover execution phase 535 to update transmission parameters (e.g., such as RI, CQI, and PMI) that may enable subsequent data transmissions to satisfy a quality threshold. However, performing the handover execution phase 535 and the aperiodic CSI reporting procedure in sequence may be associated with a reduction in data throughput. For example, both handover and CSI reporting between the network node 110 and UE 120 may be associated with a duration where data throughput may be reduced such that the network node 110 and UE 120 may establish a link for wireless communications. Accordingly, transmitting the PDCCH message 605 after the handover execution phase 535 may result in data throughput degradation between the network node 110 and the UE 120.

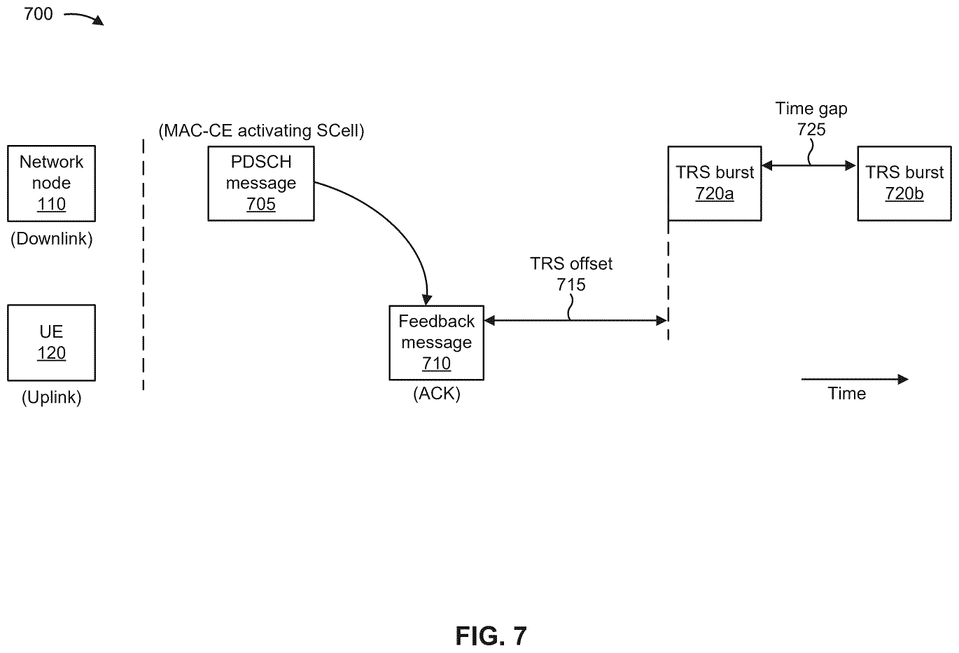

FIG. 7 is a diagram illustrating an example 700 of secondary cell (SCell) activation in accordance with MAC-CEs. In some instances, example 700 may implement or be implemented by one or more aspects of FIGS. 1 through 6. For instance, FIG. 7 may illustrate wireless communications between the network node 110 and the UE 120.

As shown in FIG. 7, the network node 110 may transmit, and the UE 120 may receive, a PDSCH message 705 that activates an SCell of the network node 110. For example, the PDSCH message 705 may include a MAC-CE that activates the SCell for communications with the UE 120. For example, if the UE 120 operates in carrier aggregation (CA), the network node 110 may dynamically activate or deactivate additional SCells based on traffic demands and network conditions. The MAC-CE in the PDSCH message 705 may serve as a signaling mechanism to instruct the UE 120 to start monitoring and communicating over an identified SCell.

In accordance with receiving the PDSCH message 705, the UE 120 may decode the MAC-CE, which may include information such as the SCell index and activation state. Additionally, the PDSCH message 705 may request for the UE 120 to transmit a feedback message 710 associated with the PDSCH. For example, the feedback message 710 may include a HARQ-ACK indication if the UE 120 successfully receives and decodes the PDSCH message 705. Alternatively, the feedback message 710 may include a HARQ-NACK indication if the UE 120 is unable to receive or decode the PDSCH message 705.

In some examples, the PDSCH message 705 may additionally trigger the transmission of one or more TRS bursts 720 (e.g., TRS bursts 720a and 720b). For example, TRSs may be reference signals transmitted by the network node 110 to assist the UE 120 in tracking and estimating long-term channel variations (e.g., Doppler shifts and time/frequency offsets). In some examples, the network node 110 may dynamically trigger one or more TRS bursts 720 via a MAC-CE included in the PDSCH message 705. For example, the MAC-CE may indicate the TRS burst 720a and the TRS burst 720b (with a time gap 725 in between). Such dynamic triggering of the TRS bursts 720 enables the network node 110 to increase resource utilization while maintaining accurate channel estimation.

In some examples, there may be a TRS offset 715 associated with the TRS bursts 720. For example, the TRS offset 715 may be a duration between an end of a last time interval that includes the feedback message 710 and a start of a time interval that includes the TRS burst 720a. In some examples, the TRS offset 715 may be configured via control signaling (e.g., RRC signaling). For example, the TRS offset 715 may be indicated via a parameter aperiodicTriggeringOffsetL2-r17 which may be included in the NZP-CSI-RS-ResourceSet, described elsewhere herein. In some examples, the parameter aperiodicTriggeringOffsetL2-r17 may indicate a triggering offset of aperiodic NZP CSI-RS resources used for activation of an SCell, where the NZP CSI-RS resources may be activated by a MAC-CE. In some examples, the aperiodicTriggeringOffsetL2-r17 may be an integer indicating a number of time intervals (e.g., a number of slots).

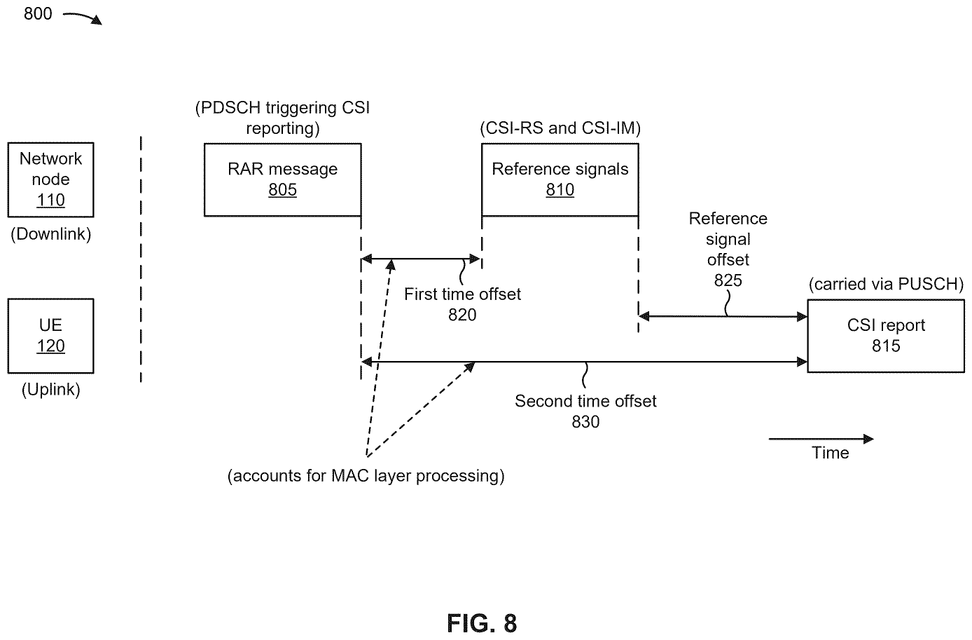

FIG. 8 is a diagram illustrating an example 800 associated with an RAR trigger for CSI reporting. In some instances, example 800 may implement or be implemented by one or more aspects of FIGS. 1 through 7. For instance, FIG. 8 may illustrate wireless communications between the network node 110 and the UE 120.

As shown in FIG. 8, the network node 110 may transmit, and the UE 120 may receive, an RAR message 805 (e.g., as part of a RACH procedure). For example, the RAR message 805 may be an example of the RAR message shown by reference number 335 (e.g., msgB according to the two-step RACH procedure) or the RAR message shown by reference number 415 (e.g., msg2 according to the four-step RACH procedure). Additionally, the network node 110 may transmit the RAR message 805 via a PDSCH. In some examples, the RAR message 805 may include one or more RAR grant fields as shown in Table 1:

TABLE 1

| RAR grant field | Number of bits |
|---|---|
| Frequency hopping flag | 1 |
| PUSCH frequency resource | 12, for operation with shared spectrum |
| allocation | channel access in FR1 or for FR2 when |
| | ChannelAccessMode2-r17 is provided |
| | 14, otherwise |
| PUSCH time resource | 4 |
| allocation | |
| MCS | 4 |
| TPC command for PUSCH | 3 |
| CSI request | 1 |
| ChannelAccess-CPext | 2, for operation with shared spectrum |
| | channel access in FR1 for FR2-2 when |
| | ChannelAccessMode2-r17 is provided |
| | 0, otherwise |

In some examples, RAR grant fields of the RAR message may indicate information used by the UE 120 to perform uplink transmissions.

With reference to Table 1, the frequency hopping flag field may include one bit that indicates whether frequency hopping is enabled for uplink transmissions. If the frequency hopping flag field is a first value (e.g., ‘0’) then frequency hopping is disabled, and if the frequency hopping flag field is a second value (e.g., ‘1’) then frequency hopping is enabled (e.g., allowing the UE 120 to change frequencies for uplink transmissions to improve signal diversity).

With reference to Table 1, the PUSCH frequency resource allocation field may indicate uplink frequency resources allocated for a PUSCH used by the UE 120 to transmit uplink transmissions. In some examples, the number of bits included in the PUSCH frequency resource allocation field may be based on an operational mode. For example, the PUSCH frequency resource allocation field may include 12 bits (e.g., for shared spectrum access in FR1 (sub-6 GHz) or FR2-2 (higher mmWave frequencies)) when ChannelAccessMode2-r17 is provided as part of an RRC configuration transmitted from the network node 110 to the UE 120. Alternatively, the PUSCH frequency resource allocation field may include 14 bits if ChannelAccessMode2-r17 is not provided.

With reference to Table 1, the PUSCH time resource allocation field may indicate the uplink time-domain resource allocation for a PUSCH transmission. In some examples, the PUSCH time resource allocation field may include four bits associated with a set of row indexes, as shown in Table 2:

TABLE 2

| | PUSCH | | | |
|---|---|---|---|---|
| Row index | mapping type | K₂ | S | L |
| 1 | Type A | j | 0 | 14 |
| 2 | Type A | j | 0 | 12 |
| 3 | Type A | j | 0 | 10 |
| 4 | Type B | j | 2 | 10 |
| 5 | Type B | j | 4 | 10 |
| 6 | Type B | j | 4 | 8 |
| 7 | Type B | j | 4 | 6 |
| 8 | Type A | j + 1 | 0 | 14 |
| 9 | Type A | j + 1 | 0 | 12 |
| 10 | Type A | j + 1 | 0 | 10 |
| 11 | Type A | j + 2 | 0 | 14 |
| 12 | Type A | j + 2 | 0 | 12 |
| 13 | Type A | j + 2 | 0 | 10 |
| 14 | Type B | j | 8 | 6 |
| 15 | Type A | j + 3 | 0 | 14 |
| 16 | Type A | j + 3 | 0 | 10 |

For example, a row index from the set of row indexes may point to a PUSCH mapping type, a K₂ value, an S value, and an L value. The PUSCH mapping type may be of Type-A or Type-B. For example, Type-A may be associated with a fixed starting symbol (e.g., the PUSCH transmission starts at a predefined symbol position within the slot). For examples, if PUSCH mapping Type-A starts at symbol 2, then one or more PUSCH transmissions may begin in symbol 2 of a slot. Alternatively, Type-B may be associated with a starting symbol that may be dynamically assigned by the network node 110. For example, the network node 110 may schedule a first PUSCH transmission to start at symbol 4 of a first slot and a second PUSCH transmission to start at symbol 6 of a second slot. The K₂ value may indicate a time interval offset relative to a last time interval that includes the RAR message 805 (e.g., where j is an integer). The S value may be a starting symbol that indicates a starting OFDM symbol index within a slot where a PUSCH transmission starts. The L value may be a duration that indicates a number of consecutive symbols allocated for the PUSCH transmission.

Additionally, the value of j, with reference to the K₂ value, may be provided with reference to Table 3:

TABLE 3

| μPUSCH | j |
|---|---|
| 0 | 1 |
| 1 | 1 |
| 2 | 2 |
| 3 | 3 |
| 5 | 11 |
| 6 | 21 |

With reference to Table 3, μPUSCH may be a numerology of an uplink transmission, where a u value corresponds to a specific SCS. For example, the set of u values [0, 1, 2, 3, 5, 6] are respectively associated with a set of SCS values [15 kHz, 30 kHz, 60 kHz, 120 kHz, 480 kHz, 960 kHz]. Additionally, as shown in Table 3, different numerologies (μPUSCH values) have different values of j, which means that different time offsets may apply based on the SCS. Therefore, Table 3 may be associated with indicating a time offset for the UE 120 to apply to one or more PUSCH transmissions.

In some examples, the UE 120 may apply an additional slot delay (e.g., in addition to the j value) for a first transmission of PUSCH scheduled by the RAR message 805. Such an additional time interval delay (4) may be provided with reference to Table 4:

TABLE 4

| μPUSCH | Δ |
|---|---|
| 0 | 2 |
| 1 | 3 |
| 2 | 4 |
| 3 | 6 |
| 5 | 24 |
| 6 | 48 |

With reference to Table 4, the Δ value may indicate an additional time interval delay for the first (e.g., initial) transmission of PUSCH scheduled by the RAR message 805 or by a fallback RAR message. When the UE 120 transmits a PUSCH scheduled by the RAR message 805 or by a fallback RAR message, the Δ value may be specific to the PUSCH SCS spacing (μPUSCH) applied in addition to the K₂ value.

With reference to Table 1, the MCS field may indicate the modulation order and the coding rate for the UE 120 to use for PUSCH transmissions.

With reference to Table 1, the TPC command for PUSCH field may indicate the TPC adjustment for PUSCH transmissions. In other words, the TPC command for PUSCH field enables the UE 120 to adjust transmission power to increase a likelihood of reception at the network node 110 while reducing interference.

With reference to Table 1, the CSI request field may indicate whether the UE 120 should report CSI as part of a PUSCH transmission. For example, if the CSI request field is of a first value (e.g., ‘0’) then a CSI report is not requested. If the CSI request field is of a second value (e.g., ‘1’), then the UE 120 may include a CSI report with the initial PUSCH transmission scheduled by the RAR message 805. In other words, the CSI request field included in the RAR message 805 may trigger CSI reporting for aperiodic CSI-RS or CSI-IM measurement.

With reference to Table 1, the ChannelAccess-CPext field may be used for operations in a shared spectrum environment (or in FR2-2 if ChannelAccessMode2-r17 is enabled). If shared spectrum access is used, then two bits may be allocated in the RAR message 805 to indicate the access parameters that enable the shared spectrum access. If shared spectrum access is not used, the ChannelAccess-CPext may include zero bits (e.g., not included in the RAR message 805).

In some examples, the UE 120 may decode the PUSCH that carries the RAR message 805, and process the RAR message 805 via the MAC layer. For example, the MAC layer of the UE 120 may extract a MAC RAR subheader and a MAC RAR payload from the RAR message 805, which may include information such as uplink grant parameters (frequency and time domain resources for PUSCH transmission), a cell radio network temporary identifier (C-RNTI) associated with the UE 120 for identification, a timing advance command (to adjust uplink synchronization), and the CSI request. The UE 120 may process RAR grant fields to adjust an uplink timing, prepare a scheduled uplink transmission on PUSCH, and, if assigned, transmit additional control information such as CSI. This MAC layer processing ensures that the UE 120 correctly interprets the RAR message 805, enabling successful contention resolution and further communication establishment with the network node 110.

In accordance with the RAR message 805 triggering CSI reporting (via the CSI request field), the network node 110 may transmit, and the UE 120 may receive, the one or more reference signals 810. In some examples, the one or more reference signals 810 may include one or more of CSI-RSs or CSI-IMs.

In accordance with receiving the reference signals 810, the UE 120 may measure, process, and generate a CSI report 815 based on one or more configured feedback parameters. In some examples, the CSI report 815 may include one or more of an RI (e.g., indicates a number of spatial layers that the transmission channel may support), a CQI (e.g., indicates a permissible MCS that can be used for data transmissions), or a PMI (e.g., indicates feedback on a precoding scheme for MIMO transmissions).

After generating the CSI report 815, the UE 120 may transmit, and the network node 110 may receive, the CSI report 815 via a PUSCH. Accordingly, the network node 110 may decode the CSI report 815 and dynamically adapt transmission parameters associated with the transmission channel in accordance with the one or more parameters included in the CSI report 815.

By triggering the CSI reporting via the RAR message 805, the network node 110 and the UE 120 may perform the CSI reporting earlier, as compared to CSI reporting triggered by PDCCH as described with reference to FIG. 6. In some examples, however, the UE 120 processing the RAR message 805 via the MAC layer may take more time compared to processing a PDCCH grant included in the PDCCH message 605 via the PHY layer. In other words, processing via the MAC layer may be associated with more latency compared to processing via the PHY layer.

Accordingly, the UE 120 may use a different aperiodic CSI-RS/CSI-IM transmission timeline triggered by the RAR message 805, as compared to the aperiodic CSI-RS/CSI-IM transmission timeline triggered by the PDCCH message 605. For example, as shown in FIG. 8, the network node 110 may transmit, and the UE 120 may receive, the one or more reference signals 810 in accordance with a first time offset 820 (e.g., different from the CSI-RS triggering offset 630). Additionally, the UE 120 may transmit, and the network node 110 may receive, the CSI report 815 in accordance with a second time offset 830 (e.g., different from the PDCCH offset 620).

In some examples, the first offset 820 includes an additional scheduling offset that is applied on top of the aperiodicTriggeringOffset, described elsewhere herein. For example, the NZP-CSI-RS-ResourceSet configured at the UE 120 may indicate the aperiodicTriggeringOffset, where the first offset 820 may be equal to a sum of the aperiodicTriggeringOffset and the additional scheduling offset. In some examples, the UE 120 may identify the additional scheduling offset in accordance with Table 4. For example, the additional scheduling offset may be equal to the Δ value associated with the SCS of the PDSCH that carries the RAR message 805 and the SCS of the one or more reference signals 810. For example, if the SCS associated with the RAR message 805 and the one or more reference signals 810 is equal to 30 kHz (e.g., μ=1), then the additional scheduling offset is three time intervals (e.g., three slots). If the SCS of the PDSCH that carries the RAR message 805 is different than the SCS of the one or more reference signals 810, then the UE 120 may select the Δ value in accordance with the smaller SCS. For instance, if the SCS associated with the RAR message 805 is equal to 30 kHz (e.g., μ=1) and the SCS associated with the one or more reference signals 810 is equal to 15 kHz (e.g., μ=0), then the additional scheduling offset is two time intervals (e.g., two slots). In some examples, the first offset 820 being equal to zero may correspond to the time interval with the PDSCH that carries the RAR message 805. By adding an additional time offset to the aperiodicTriggeringOffset, the network node 110 may account for PDSCH decoding and MAC layer processing of the RAR message 805. Additionally, by leveraging the aperiodicTriggeringOffset and the Δ value to determine the first offset 820, the UE 120 may identify when to monitor and receive the one or more reference signals 810 using parameters previously configured at the UE 120, which may reduce signaling overhead.

In some examples, the first offset 820 is configured via aperiodicTriggeringOffsetL2, described elsewhere herein. For example, the NZP-CSI-RS-ResourceSet configured at the UE 120 may indicate aperiodicTriggeringOffsetL2. In some examples of the first offset 820, the aperiodicTriggeringOffsetL2 is applied relative to time interval n, where time interval n may be the time interval with the PDSCH that carries the RAR message 805. In some examples, the aperiodicTriggeringOffsetL2 is applied relative to time interval n+k, where the k value may be specified for each numerology. For example, the k value may be the K₂ value, the j value, or the Δ value associated with one of Tables 2, 3, or 4. In some other examples, the k value may be defined per numerology in a table separate from and different than Tables 2, 3, and 4. Therefore, the k value may be based on the SCS of the PDSCH that carries the RAR message 805 and the SCS of the one or more reference signals 810. For example, if the SCS associated with the RAR message 805 and the one or more reference signals 810 is equal to 30 kHz (e.g., μ=1), then the k value is equal to a value that points to μ=1 in the k value related Table. If the SCS of the PDSCH that carries the RAR message 805 is different than the SCS of the one or more reference signals 810, then the UE 120 may select the k value in accordance with the smaller SCS. For instance, if the SCS associated with the RAR message 805 is equal 30 kHz (e.g., μ=1) and the SCS associated with the one or more reference signals 810 is equal to 15 kHz (e.g., μ=0), then the k value is equal to a value that points to μ=0 in the k value related Table. By leveraging the aperiodicTriggeringOffsetL2 as the first time offset 820, the network node 110 may account for PDSCH decoding and MAC layer processing of the RAR message 805. Additionally, by leveraging the aperiodicTriggeringOffsetL2 to determine the first offset 820, the UE 120 may identify when to monitor and receive the one or more reference signals 810 using parameters previously configured at the UE 120, which may reduce signaling overhead.

In some examples, the first offset 820 may be configured via an additional RRC parameter that is different from the aperiodicTriggeringOffset and the aperiodicTriggeringOffsetL2. For example, the additional RRC parameter may be included in the NZP-CSI-RS-ResourceSet as part of the RRC configuration. In some examples, the additional RRC parameter may be configured per NZP-CSI-RS resource set. In some examples, the additional RRC parameter may be configured as a common parameter applicable to multiple (e.g., all) configured NZP-CSI-RS resource sets. In some examples, the additional RRC parameter may be defined relative to the time interval with the PDSCH that carries the RAR message 805. In some examples, a wireless communications standard (such as 3GPP) may define a permissible (e.g., minimum value) of the first time offset 820 per numerology (e.g., per u value [0, 1, 2, 3, 5, 6] respectively associated with an SCS value [15 kHz, 30 kHz, 60 kHz, 120 kHz, 480 kHz, 960 kHz]). If the SCS of the PDSCH that carries the RAR message 805 is different than the SCS of the one or more reference signals 810, then the UE 120 may select the time offset 820 value in accordance with the smaller SCS. By using the additional RRC parameter as the first time offset 820, the network node 110 may account for PDSCH decoding and MAC layer processing of the RAR message 805. Additionally, leveraging an additional RRC parameter (e.g., rather than the aperiodicTriggeringOffset or the aperiodicTriggeringOffsetL2) to determine the first offset 820 may enable more flexibility in how the network node 110 configures the multiple parameters of the NZP-CSI-RS-ResourceSet.

In some examples, the second offset 830 may be greater than the PDCCH offset 620. For example, if the PDCCH offset 620 is a value of Z, then the second offset 830 is value of Z+D. In some examples, the value of Z is with reference to a last PDSCH symbol carrying the RAR message 805. In some examples, the UE 120 may apply an additional delay of D on top of Z to accommodate PDSCH decoding and MAC processing delay associated with the RAR message 805. In some examples, a wireless communications standard (such as 3GPP) may define a permissible (e.g., minimum value) of the additional delay of D per numerology (e.g., per μ value [0, 1, 2, 3, 5, 6] respectively associated with an SCS value [15 kHz, 30 kHz, 60 kHz, 120 kHz, 480 kHz, 960 kHz]).

In some examples, the second offset 830 may be equal to the sum of the K₂ value indicated in the RAR message 805 and the Δ value. For example, because the CSI report 815 is a first PUSCH transmission after the RAR message 805, the UE 120 applies the Δ value on top of the K₂ value. Accordingly, the network node 110 may select a value for the PUSCH time resource allocation field to indicate a K₂ value such that the sum of the K₂ value and the Δ value (associated with the SCS of the PUSCH that carries the CSI report 815) may satisfy a duration of time for the UE 120 to perform PDSCH decoding and MAC layer processing for the RAR message 805. For instance, in one example, the SCS associated with the CSI report may be 30 kHz (e.g., j=1 and Δ=3) and the PUSCH time resource allocation field of the RAR message 805 may indicate row index 15 (e.g., K₂=j+3). In such an example, the sum of the K₂ value and the Δ value may provide the UE 120 with enough time to decode the PDSCH carrying the RAR message 805, process the RAR message 805 via the MAC layer, measure the one or more reference signals, and generate the CSI report (e.g., K₂+Δ=7 time intervals, which satisfies a duration of time to perform PDSCH decoding and MAC layer processing).

In some examples, the time interval during which the UE 120 transmits the CSI report 815 may satisfy both the second time offset 830 and the reference signal offset 825. In some examples, the reference signal offset 825 may be the same as the reference signal offset 625 (e.g., Z′).

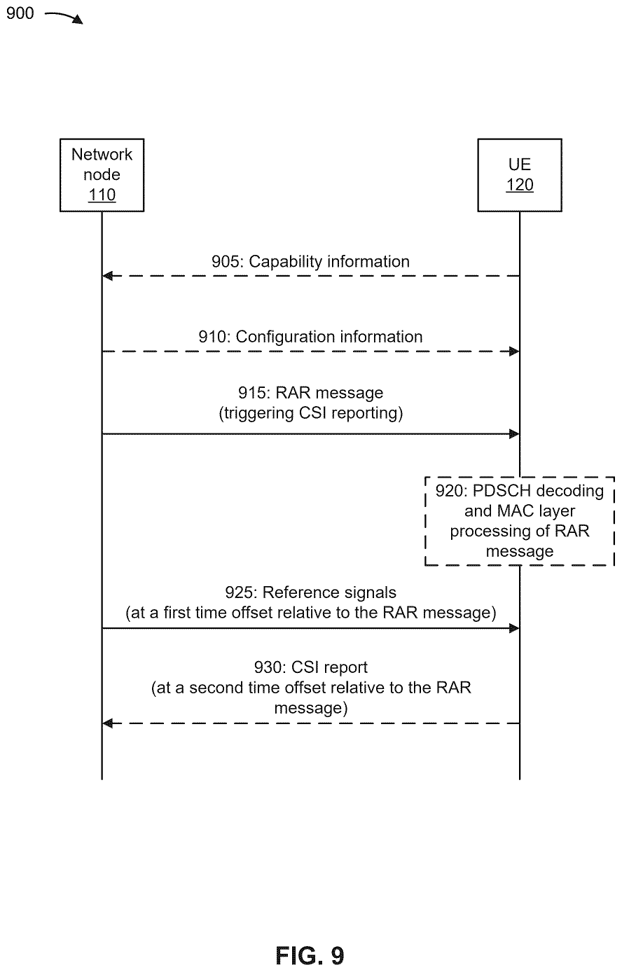

FIG. 9 is a diagram illustrating an example 900 associated with signaling that enables RAR message triggering for CSI reporting. Example 900 may implement or be implemented by one or more aspects of FIGS. 1 through 8. For instance, example 900 includes wireless communications between the network node 110 and the UE 120. Alternative examples of the following may be implemented, where some operations are performed in a different order than described, or not described at all. In some cases, one or more operations may include additional features not mentioned below, or further operations may be added. In addition, while example 900 shows operations between the UE 120 and the network node 110, the communications may occur between any number of network devices of various types described herein.

In a first operation 905, the UE 120 may optionally transmit, and the network node 110 may receive, capability information. The capability information may be included in a capability report. The UE 120 may transmit the capability information via an uplink communication, a sidelink communication, a unicast communication, a broadcast communication, a UE 120 assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), or a physical sidelink shared channel (PSSCH)), among other examples. The capability information may indicate one or more parameters associated with respective capabilities of the UE 120. The one or more parameters may be indicated via respective IEs included in a capability report.

The capability information may indicate whether the UE 120 supports a feature or one or more parameters related to the feature. For example, the capability information may indicate a capability or parameter of a duration associated with PDSCH decoding and MAC layer processing. In some examples, the capability information may indicate a capability or parameter for support to receive an RAR message that triggers CSI reporting. In some examples, the UE 120 may transmit the capability information directly to the network node 110. In some examples, the network node 110 may obtain the capability information from another network node 110. For example, the network node 110 may be a target network node (e.g., target network node 515) that obtains the capability information from a source network node (e.g., source network node 510), where the source network node receives the capability information from the UE 120.

The network node 110 may determine configuration information for the UE 120 based on the capability information. For example, the network node 110 may determine that the UE 120 is capable of receiving an RAR message that triggers CSI reporting based on the capability information. Additionally, the network node 110 may determine a duration of time associated with the UE 120 performing PDSCH decoding and MAC layer processing based on the capability information.

In a second operation 910, the network node 110 may optionally transmit, and the UE 120 may receive, the configuration information. In some aspects, the UE 120 may receive the configuration information via one or more of system information signaling (e.g., a master information block (MIB) or a SIB, among other examples), RRC signaling, MAC signaling (e.g., one or more MAC-CEs), or DCI, among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may indicate a candidate configuration or communication parameter from the one or more candidate configurations or communication parameters. In some aspects, the subsequent indication may include a dynamic indication, such as one or more MAC-CEs or one or more DCI messages, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information). For example, one or more of Tables 1 through 4 or any other tables described herein may be at least partially defined by a wireless communication standard, such as the 3GPP, or at least partially stored by the UE 120 in an OEM configuration.

In some examples, the configuration information may include control signaling (e.g., RRC signaling) that configures the NZP-CSI-RS-ResourceSet parameters, as described elsewhere herein. For example, the NZP-CSI-RS-ResourceSet parameters may include one or more of the parameter aperiodicTriggeringOffset, the parameter aperiodicTriggeringOffsetL2, or an additional RRC parameter (e.g., described with reference to FIG. 8), among other examples. In some examples, the UE 120 may receive the configuration information from the network node 110. In some other examples, the UE 120 may receive the configuration information from another network node 110 (e.g., a previous source network node prior to performing a handover procedure to the network node 110).

In a third operation 915, the network node 110 may transmit, and the UE 120 may receive, an RAR message. In some examples, the RAR message may trigger CSI reporting. For example, the RAR message of the third operation 915 may be an example of the RAR message 805.

In a fourth operation 920, the UE 120 may perform PDSCH decoding and MAC layer processing for the RAR message, as described elsewhere herein. In some examples, the performing of the PDSCH decoding and the MAC layer processing may be associated with the duration of time (e.g., as optionally indicated in the capability information).

In a fifth operation 925, the network node 110 may transmit, and the UE 120 may receive, one or more reference signals (e.g., the reference signals 610 or 810) in accordance with the RAR message triggering the CSI reporting. In some examples, the one or more reference signals may be indicated by, included in, or associated with the NZP-CSI-RS-ResourceSet parameters. In some examples, the network node 110 may transmit the one or more reference signals at a first time offset relative to the RAR message (e.g., the first time offset 820).

In some examples, the UE 120 may receive control signaling (e.g., as part of the configuration information) that indicates an aperiodic time offset that spans from a last symbol of a downlink message for scheduling one or more CSI-RSs to an initial symbol of the one or more CSI reference signals (e.g., the aperiodicTriggeringOffset). In such examples, the first time offset may be equal to a sum of the aperiodic time offset and an additional scheduling offset (e.g., Δ value, with reference to Table 4). For example, the additional scheduling offset may be based on a smaller SCS with respect to a first SCS associated with the RAR message and a second SCS associated with the one or more reference signals.

In some examples, the UE 120 may receive control signaling (e.g., as part of the configuration information) that indicates a TRS time offset (e.g., TRS offset 715 or aperiodicTriggeringOffsetL2). In such examples, the first time offset may be equal to the TRS time offset. If the first time offset equals the TRS time offset, then the first time offset may span from a last symbol of the RAR message to an initial symbol of the one or more reference signals (e.g., n time intervals, with reference to FIG. 8). Alternatively, the first time offset may span from a configured time after a last symbol of the RAR message to an initial symbol of the one or more reference signals (e.g., n+k time intervals, with reference to FIG. 8). In such an example, the configured time (e.g., the k value) may be based on a smaller SCS with respect to a first SCS associated with the RAR message and a second SCS associated with the one or more reference signals.

In some examples, the UE 120 may receive control signaling (e.g., as part of the configuration information) that indicates the first time offset via the additional RRC parameter (e.g., different than the aperiodicTriggeringOffset and the aperiodicTriggeringOffsetL2). In such an example, the additional RRC parameter may indicate that the first time offset spans from a last symbol of the RAR message to an initial symbol of the one or more reference signals. In some examples, the additional RRC parameter may be from a set of additional RRC parameters that respectively indicate a set of first time offsets respectively configured for a set of CSI-RS resource sets. In some examples, the additional RRC parameter may be a common parameter that indicates the first time offset for multiple CSI-RS resource sets.

In some examples, the first time offset may be based on or account for the duration of time associated with the UE 120 performing PDSCH decoding and MAC layer processing for the RAR message (e.g., as optionally indicated in the capability information).

In a sixth operation 930, the UE 120 may transmit, and the network node 110 may receive, a CSI report in accordance with the one or more reference signals (e.g., the CSI report 815). For example, the UE 120 may transmit the CSI report at a second time offset relative to the RAR message (e.g., the second time offset 830). In some examples, the second time offset may satisfy or account for the duration of time associated with the UE 120 performing PDSCH decoding and MAC layer processing for the RAR message (e.g., as optionally indicated in the capability information). In some examples, a set of bits of a time domain resource allocation field included in the RAR message may indicate the second time offset (e.g., the K₂ value, or the sum of the K₂ value and the Δ value associated with the PUSCH for transmission of the CSI report). In some examples, the second time offset spans from a last symbol that carries the RAR message to an initial symbol that carries the CSI report.

FIG. 10 is a diagram illustrating an example process 1000 performed, for example, at a UE or an apparatus of a UE. Example process 1000 is an example where the apparatus or the UE (e.g., UE 120) performs operations associated with techniques for random access response triggering for CSI reporting.

As shown in FIG. 10, in some aspects, process 1000 may include receiving, from a network node, an RAR message that triggers CSI reporting (block 1010). For example, the UE (e.g., using reception component 1202 or communication manager 1206, depicted in FIG. 12) may receive, from a network node, a RAR message that triggers CSI reporting, as described above.

As further shown in FIG. 10, in some aspects, process 1000 may include receiving, from the network node at a first time offset relative to the RAR message, one or more reference signals in accordance with the RAR message triggering the CSI report (block 1020). For example, the UE (e.g., using reception component 1202 or communication manager 1206, depicted in FIG. 12) may receive, from the network node at a first time offset relative to the RAR message, one or more reference signals in accordance with the RAR message triggering the CSI report, as described above.

As further shown in FIG. 10, in some aspects, process 1000 may include transmitting, to the network node at a second time offset relative to the RAR message, a CSI report in accordance with the one or more reference signals (block 1030). For example, the UE (e.g., using transmission component 1204 or communication manager 1206, depicted in FIG. 12) may transmit, to the network node at a second time offset relative to the RAR message, a CSI report in accordance with the one or more reference signals, as described above.

Process 1000 may include additional aspects, such as any single aspect or any combination of aspects described below or in connection with one or more other processes described elsewhere herein.

In a first aspect, a set of bits of a time domain resource allocation field included in the RAR message indicates the second time offset.

In a second aspect, alone or in combination with the first aspect, the second time offset satisfies a duration threshold associated with PDSCH decoding and MAC layer processing.

In a third aspect, alone or in combination with one or more of the first and second aspects, the second time offset spans from a last symbol that carries the RAR message to an initial symbol that carries the CSI report.

In a fourth aspect, alone or in combination with one or more of the first through third aspects, process 1000 includes receiving control signaling that indicates an aperiodic time offset that spans from a last symbol of a downlink message for scheduling one or more CSI-RSs to an initial symbol of the one or more CSI reference signals, wherein the first time offset is equal to a sum of the aperiodic time offset and an additional scheduling offset.

In a fifth aspect, alone or in combination with one or more of the first through fourth aspects, the additional scheduling offset is based at least in part on a smaller SCS with respect to a first SCS associated with the RAR message and a second SCS associated with the one or more reference signals.

In a sixth aspect, alone or in combination with one or more of the first through fifth aspects, process 1000 includes receiving control signaling that indicates a TRS time offset, wherein the first time offset is equal to the TRS time offset.

In a seventh aspect, alone or in combination with one or more of the first through sixth aspects, the first time offset spans from a last symbol of the RAR message to an initial symbol of the one or more reference signals.

In an eighth aspect, alone or in combination with one or more of the first through seventh aspects, the first time offset spans from a configured time after a last symbol of the RAR message to an initial symbol of the one or more reference signals.

In a ninth aspect, alone or in combination with one or more of the first through eighth aspects, the configured time is based at least in part on a smaller SCS with respect to a first SCS associated with the RAR message and a second SCS associated with the one or more reference signals.

In a tenth aspect, alone or in combination with one or more of the first through ninth aspects, process 1000 includes receiving control signaling that indicates the first time offset, wherein the first time offset spans from a last symbol of the RAR message to an initial symbol of the one or more reference signals.

In an eleventh aspect, alone or in combination with one or more of the first through tenth aspects, the control signaling indicates a set of first time offsets that includes the first time offset, and the set of time offsets are respectively configured for a set of CSI-RS resource sets.

In a twelfth aspect, alone or in combination with one or more of the first through eleventh aspects, the first time offset is a common parameter applicable to multiple CSI-RS resource sets.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node. Example process 1100 is an example where the apparatus or the network node (e.g., network node 110) performs operations associated with techniques for random access response triggering for CSI reporting.

As shown in FIG. 11, in some aspects, process 1100 may include transmitting, to a UE, an RAR message that triggers CSI reporting (block 1110). For example, the network node (e.g., using transmission component 1304 or communication manager 1306, depicted in FIG. 13) may transmit, to a UE, an RAR message that triggers CSI reporting, as described above.

As further shown in FIG. 11, in some aspects, process 1100 may include transmitting, to the UE, at a first time offset relative to the RAR message, one or more reference signals in accordance with the RAR message triggering the CSI report (block 1120). For example, the network node (e.g., using transmission component 1304 or communication manager 1306, depicted in FIG. 13) may transmit, to the UE, at a first time offset relative to the RAR message, one or more reference signals in accordance with the RAR message triggering the CSI report, as described above.

As further shown in FIG. 11, in some aspects, process 1100 may include receiving, from the UE at a second time offset relative to the RAR message, a CSI report in accordance with the one or more reference signals (block 1130). For example, the network node (e.g., using reception component 1302 or communication manager 1306, depicted in FIG. 13) may receive, from the UE at a second time offset relative to the RAR message, a CSI report in accordance with the one or more reference signals, as described above.

Process 1100 may include additional aspects, such as any single aspect or any combination of aspects described below or in connection with one or more other processes described elsewhere herein.

In a first aspect, a set of bits of a time domain resource allocation field included in the RAR message indicates the second time offset.

In a second aspect, alone or in combination with the first aspect, the second time offset satisfies a duration threshold associated with PDSCH decoding and MAC layer processing.

In a third aspect, alone or in combination with one or more of the first and second aspects, the second time offset spans from a last symbol that carries the RAR message to an initial symbol that carries the CSI report.

In a fourth aspect, alone or in combination with one or more of the first through third aspects, process 1100 includes transmitting control signaling that indicates an aperiodic time offset that spans from a last symbol of a downlink message for scheduling one or more CSI-RSs to an initial symbol of the one or more CSI reference signals, wherein the first time offset is equal to a sum of the aperiodic time offset and an additional scheduling offset.

In a fifth aspect, alone or in combination with one or more of the first through fourth aspects, the additional scheduling offset is based at least in part on a smaller SCS with respect to a first SCS associated with the RAR message and a second SCS associated with the one or more reference signals.

In a sixth aspect, alone or in combination with one or more of the first through fifth aspects, process 1100 includes transmitting control signaling that indicates a TRS time offset, wherein the first time offset is equal to the TRS time offset.

In a seventh aspect, alone or in combination with one or more of the first through sixth aspects, the first time offset spans from a last symbol of the RAR message to an initial symbol of the one or more reference signals.

In an eighth aspect, alone or in combination with one or more of the first through seventh aspects, the first time offset spans from a configured time after a last symbol of the RAR message to an initial symbol of the one or more reference signals.

In a ninth aspect, alone or in combination with one or more of the first through eighth aspects, the configured time is based at least in part on a smaller SCS with respect to a first SCS associated with the RAR message and a second SCS associated with the one or more reference signals.

In a tenth aspect, alone or in combination with one or more of the first through ninth aspects, process 1100 includes transmitting control signaling that indicates the first time offset, wherein the first time offset spans from a last symbol of the RAR message to an initial symbol of the one or more reference signals.

In an eleventh aspect, alone or in combination with one or more of the first through tenth aspects, the control signaling indicates a set of first time offsets that includes the first time offset, and the set of time offsets are respectively configured for a set of CSI-RS resource sets.

In a twelfth aspect, alone or in combination with one or more of the first through eleventh aspects, the first time offset is a common parameter applicable to multiple CSI-RS resource sets.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202, a transmission component 1204, or a communication manager 1206, which may be in communication with one another (for example, via one or more buses or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 140 described in connection with FIG. 1) of the UE.

In some aspects, the apparatus 1200 may be configured to perform one or more operations described herein in connection with FIGS. 3 through 9. Additionally, or alternatively, the apparatus 1200 may be configured to perform one or more processes described herein, such as process 1000 of FIG. 10. In some aspects, the apparatus 1200 or one or more components shown in FIG. 12 may include one or more components of the UE described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the UE described above in connection with FIG. 1, such as a radio, one or more RF chains, one or more transceivers, or one or more modems, each of which may in turn be coupled with one or more antennas of the UE.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1204 may be co-located with the reception component 1202.

The communication manager 1206 may support operations of the reception component 1202 or the transmission component 1204. For example, the communication manager 1206 may receive information associated with configuring reception of communications by the reception component 1202 or transmission of communications by the transmission component 1204. Additionally, or alternatively, the communication manager 1206 may generate or provide control information to the reception component 1202 or the transmission component 1204 to control reception or transmission of communications.

The reception component 1202 may receive, from a network node, an RAR message that triggers CSI reporting. The reception component 1202 may receive, from the network node at a first time offset relative to the RAR message, one or more reference signals in accordance with the RAR message triggering the CSI report. The transmission component 1204 may transmit, to the network node at a second time offset relative to the RAR message, a CSI report in accordance with the one or more reference signals.

The reception component 1202 may receive control signaling that indicates an aperiodic time offset that spans from a last symbol of a downlink message for scheduling one or more CSI-RSs to an initial symbol of the one or more CSI reference signals, wherein the first time offset is equal to a sum of the aperiodic time offset and an additional scheduling offset.

The reception component 1202 may receive control signaling that indicates a TRS time offset, wherein the first time offset is equal to the TRS time offset.

The reception component 1202 may receive control signaling that indicates the first time offset, wherein the first time offset spans from a last symbol of the RAR message to an initial symbol of the one or more reference signals.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a network node, or a network node may include the apparatus 1300. In some aspects, the apparatus 1300 includes a reception component 1302, a transmission component 1304, or a communication manager 1306, which may be in communication with one another (for example, via one or more buses or one or more other components). In some aspects, the communication manager 1306 is the communication manager 155 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 145 described in connection with FIG. 1) of the network node.

In some aspects, the apparatus 1300 may be configured to perform one or more operations described herein in connection with FIGS. 3 through 9. Additionally, or alternatively, the apparatus 1300 may be configured to perform one or more processes described herein, such as process 1100 of FIG. 11. In some aspects, the apparatus 1300 or one or more components shown in FIG. 13 may include one or more components of the network node described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the network node described above in connection with FIG. 1, such as a radio, one or more RF chains, one or more transceivers, or one or more modems, each of which may in turn be coupled with one or more antennas of the network node. In some aspects, the reception component 1302 or the transmission component 1304 may include or may be included in a network interface. The network interface may be configured to obtain or output signals for the apparatus 1300 via one or more communications links, such as a backhaul link, a midhaul link, or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1304 may be co-located with the reception component 1302.

The communication manager 1306 may support operations of the reception component 1302 or the transmission component 1304. For example, the communication manager 1306 may receive information associated with configuring reception of communications by the reception component 1302 or transmission of communications by the transmission component 1304. Additionally, or alternatively, the communication manager 1306 may generate or provide control information to the reception component 1302 or the transmission component 1304 to control reception or transmission of communications.

The transmission component 1304 may transmit, to a UE, an RAR message that triggers CSI reporting. The transmission component 1304 may transmit, to the UE, at a first time offset relative to the RAR message, one or more reference signals in accordance with the RAR message triggering the CSI report. The reception component 1302 may receive, from the UE at a second time offset relative to the RAR message, a CSI report in accordance with the one or more reference signals.

The transmission component 1304 may transmit control signaling that indicates an aperiodic time offset that spans from a last symbol of a downlink message for scheduling one or more CSI-RSs to an initial symbol of the one or more CSI reference signals, wherein the first time offset is equal to a sum of the aperiodic time offset and an additional scheduling offset.

The transmission component 1304 may transmit control signaling that indicates a TRS time offset, wherein the first time offset is equal to the TRS time offset.

The transmission component 1304 may transmit control signaling that indicates the first time offset, wherein the first time offset spans from a last symbol of the RAR message to an initial symbol of the one or more reference signals.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving, from a network node, a random access response (RAR) message that triggers channel state information (CSI) reporting; receiving, from the network node at a first time offset relative to the RAR message, one or more reference signals in accordance with the RAR message triggering the CSI report; and transmitting, to the network node at a second time offset relative to the RAR message, a CSI report in accordance with the one or more reference signals.

Aspect 2: The method of Aspect 1, wherein a set of bits of a time domain resource allocation field included in the RAR message indicates the second time offset.

Aspect 3: The method of any of Aspects 1-2, wherein the second time offset satisfies a duration threshold associated with physical downlink shared channel (PDSCH) decoding and medium access control (MAC) layer processing.

Aspect 4: The method of any of Aspects 1-3, wherein the second time offset spans from a last symbol that carries the RAR message to an initial symbol that carries the CSI report.

Aspect 5: The method of any of Aspects 1-4, further comprising: receiving control signaling that indicates an aperiodic time offset that spans from a last symbol of a downlink message for scheduling one or more CSI reference signals (CSI-RSs) to an initial symbol of the one or more CSI reference signals, wherein the first time offset is equal to a sum of the aperiodic time offset and an additional scheduling offset.

Aspect 6: The method of Aspect 5, wherein the additional scheduling offset is based at least in part on a smaller subcarrier spacing (SCS) with respect to a first SCS associated with the RAR message and a second SCS associated with the one or more reference signals.

Aspect 7: The method of any of Aspects 1-6, further comprising: receiving control signaling that indicates a traffic reference signal (TRS) time offset, wherein the first time offset is equal to the TRS time offset.

Aspect 8: The method of Aspect 7, wherein the first time offset spans from a last symbol of the RAR message to an initial symbol of the one or more reference signals.

Aspect 9: The method of Aspect 7, wherein the first time offset spans from a configured time after a last symbol of the RAR message to an initial symbol of the one or more reference signals.

Aspect 10: The method of Aspect 9, wherein the configured time is based at least in part on a smaller subcarrier spacing (SCS) with respect to a first SCS associated with the RAR message and a second SCS associated with the one or more reference signals.

Aspect 11: The method of any of Aspects 1-10, further comprising: receiving control signaling that indicates the first time offset, wherein the first time offset spans from a last symbol of the RAR message to an initial symbol of the one or more reference signals.

Aspect 12: The method of Aspect 11, wherein the control signaling indicates a set of first time offsets that includes the first time offset, and wherein the set of time offsets are respectively configured for a set of CSI reference signal (CSI-RS) resource sets.

Aspect 13: The method of Aspect 11, wherein the first time offset is a common parameter applicable to multiple CSI reference signal (CSI-RS) resource sets.

Aspect 14: A method of wireless communication performed by a network node, comprising: transmitting, to a user equipment (UE), a random access response (RAR) message that triggers channel state information (CSI) reporting; transmitting, to the UE, at a first time offset relative to the RAR message, one or more reference signals in accordance with the RAR message triggering the CSI report; and receiving, from the UE at a second time offset relative to the RAR message, a CSI report in accordance with the one or more reference signals.

Aspect 15: The method of Aspect 14, wherein a set of bits of a time domain resource allocation field included in the RAR message indicates the second time offset.

Aspect 16: The method of any of Aspects 14-15, wherein the second time offset satisfies a duration threshold associated with physical downlink shared channel (PDSCH) decoding and medium access control (MAC) layer processing.

Aspect 17: The method of any of Aspects 14-16, wherein the second time offset spans from a last symbol that carries the RAR message to an initial symbol that carries the CSI report.

Aspect 18: The method of any of Aspects 14-17, further comprising: transmitting control signaling that indicates an aperiodic time offset that spans from a last symbol of a downlink message for scheduling one or more CSI reference signals (CSI-RSs) to an initial symbol of the one or more CSI reference signals, wherein the first time offset is equal to a sum of the aperiodic time offset and an additional scheduling offset.

Aspect 19: The method of Aspect 18, wherein the additional scheduling offset is based at least in part on a smaller subcarrier spacing (SCS) with respect to a first SCS associated with the RAR message and a second SCS associated with the one or more reference signals.

Aspect 20: The method of any of Aspects 14-19, further comprising: transmitting control signaling that indicates a traffic reference signal (TRS) time offset, wherein the first time offset is equal to the TRS time offset.

Aspect 21: The method of Aspect 20, wherein the first time offset spans from a last symbol of the RAR message to an initial symbol of the one or more reference signals.

Aspect 22: The method of Aspect 20, wherein the first time offset spans from a configured time after a last symbol of the RAR message to an initial symbol of the one or more reference signals.

Aspect 23: The method of Aspect 22, wherein the configured time is based at least in part on a smaller subcarrier spacing (SCS) with respect to a first SCS associated with the RAR message and a second SCS associated with the one or more reference signals.

Aspect 24: The method of any of Aspects 14-23, further comprising: transmitting control signaling that indicates the first time offset, wherein the first time offset spans from a last symbol of the RAR message to an initial symbol of the one or more reference signals.

Aspect 25: The method of Aspect 24, wherein the control signaling indicates a set of first time offsets that includes the first time offset, and wherein the set of time offsets are respectively configured for a set of CSI reference signal (CSI-RS) resource sets.

Aspect 26: The method of Aspect 24, wherein the first time offset is a common parameter applicable to multiple CSI reference signal (CSI-RS) resource sets.

Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-26.

Aspect 28: An apparatus for wireless communication at a device, the apparatus comprising one or more memories and one or more processors coupled to the one or more memories, the one or more processors configured to cause the device to perform the method of one or more of Aspects 1-26.

Aspect 29: An apparatus for wireless communication, the apparatus comprising at least one means for performing the method of one or more of Aspects 1-26.

Aspect 30: A non-transitory computer-readable medium storing code for wireless communication, the code comprising instructions executable by one or more processors to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

Aspect 32: A device for wireless communication, the device comprising a processing system that includes one or more processors and one or more memories coupled with the one or more processors, the processing system configured to cause the device to perform the method of one or more of Aspects 1-26.

Aspect 33: An apparatus for wireless communication at a device, the apparatus comprising one or more memories and one or more processors coupled to the one or more memories, the one or more processors individually or collectively configured to cause the device to perform the method of one or more of Aspects 1-26.

Aspect 34: A device comprising a processing system that includes one or more processors and one or more code-storing memories coupled with the one or more processors, the processing system configured to cause the device to perform the method of one or more of Aspects 1-26.

Aspect 35: A device comprising a processing system that includes processor circuitry and code-storing memory circuitry, the processing system configured to cause the device to perform the method of one or more of Aspects 1-26.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors coupled to the one or more memories, the one or more processors individually or collectively configured to:
receive, from a network node, a random access response (RAR) message that triggers channel state information (CSI) reporting;
receive, from the network node at a first time offset relative to the RAR message, one or more reference signals in accordance with the RAR message triggering the CSI report; and
transmit, to the network node at a second time offset relative to the RAR message, a CSI report in accordance with the one or more reference signals.

2. The UE of claim 1, wherein a set of bits of a time domain resource allocation field included in the RAR message indicates the second time offset.

3. The UE of claim 1, wherein the second time offset satisfies a duration threshold associated with physical downlink shared channel (PDSCH) decoding and medium access control (MAC) layer processing.

4. The UE of claim 1, wherein the second time offset spans from a last symbol that carries the RAR message to an initial symbol that carries the CSI report.

5. The UE of claim 1, wherein the one or more processors are individually or collectively configured to:
receive control signaling that indicates an aperiodic time offset that spans from a last symbol of a downlink message for scheduling one or more CSI reference signals (CSI-RSs) to an initial symbol of the one or more CSI reference signals, wherein the first time offset is equal to a sum of the aperiodic time offset and an additional scheduling offset.

6. The UE of claim 5, wherein the additional scheduling offset is based at least in part on a smaller subcarrier spacing (SCS) with respect to a first SCS associated with the RAR message and a second SCS associated with the one or more reference signals.

7. The UE of claim 1, wherein the one or more processors are individually or collectively configured to:
receive control signaling that indicates a traffic reference signal (TRS) time offset, wherein the first time offset is equal to the TRS time offset.

8. The UE of claim 7, wherein the first time offset spans from a last symbol of the RAR message to an initial symbol of the one or more reference signals.

9. The UE of claim 7, wherein the first time offset spans from a configured time after a last symbol of the RAR message to an initial symbol of the one or more reference signals.

10. The UE of claim 9, wherein the configured time is based at least in part on a smaller subcarrier spacing (SCS) with respect to a first SCS associated with the RAR message and a second SCS associated with the one or more reference signals.

11. The UE of claim 1, wherein the one or more processors are individually or collectively configured to:
receive control signaling that indicates the first time offset, wherein the first time offset spans from a last symbol of the RAR message to an initial symbol of the one or more reference signals.

12. The UE of claim 11, wherein the control signaling indicates a set of first time offsets that includes the first time offset, and wherein the set of time offsets are respectively configured for a set of CSI reference signal (CSI-RS) resource sets.

13. The UE of claim 11, wherein the first time offset is a common parameter applicable to multiple CSI reference signal (CSI-RS) resource sets.

14. A method of wireless communication performed by a user equipment (UE), comprising:
receiving, from a network node, a random access response (RAR) message that triggers channel state information (CSI) reporting;
receiving, from the network node at a first time offset relative to the RAR message, one or more reference signals in accordance with the RAR message triggering the CSI report; and
transmitting, to the network node at a second time offset relative to the RAR message, a CSI report in accordance with the one or more reference signals.

15. The method of claim 14, wherein a set of bits of a time domain resource allocation field included in the RAR message indicates the second time offset.

16. The method of claim 14, wherein the second time offset satisfies a duration threshold associated with physical downlink shared channel (PDSCH) decoding and medium access control (MAC) layer processing.

17. The method of claim 14, wherein the second time offset spans from a last symbol that carries the RAR message to an initial symbol that carries the CSI report.

18. The method of claim 14, further comprising:
receiving control signaling that indicates an aperiodic time offset that spans from a last symbol of a downlink message for scheduling one or more CSI reference signals (CSI-RSs) to an initial symbol of the one or more CSI reference signals, wherein the first time offset is equal to a sum of the aperiodic time offset and an additional scheduling offset.

19. The method of claim 18, wherein the additional scheduling offset is based at least in part on a smaller subcarrier spacing (SCS) with respect to a first SCS associated with the RAR message and a second SCS associated with the one or more reference signals.

20. An apparatus for wireless communication, comprising:
means for receiving, from a network node, a random access response (RAR) message that triggers channel state information (CSI) reporting;
means for receiving, from the network node at a first time offset relative to the RAR message, one or more reference signals in accordance with the RAR message triggering the CSI report; and
means for transmitting, to the network node at a second time offset relative to the RAR message, a CSI report in accordance with the one or more reference signals.
